(19) United States
(12) Patent Application Publication
(10) Pub. No.: US 2025/0365681 A1
(43) Pub. Date: Nov. 27, 2025

(54) ENERGY-EFFICIENT INITIAL ACCESS FOR WIRELESS SYSTEMS

(71) Applicant: Samsung Electronics Co., Ltd., Suwon-si (KR)

(72) Inventors: Ebrahim MolavianJazi, San Jose, CA (US); Aristides Papasakellariou, Houston, TX (US); Hongbo Si, Allen, TX (US); Emad Nader Farag, Flanders, NJ (US)

(21) Appl. No.: 19/213,956

(22) Filed: May 20, 2025

Related U.S. Application Data
(60) Provisional application No. 63/651,903, filed on May 24, 2024.

(51) Int. Cl. H04W 56/00

(52) U.S. Cl. CPC H04W 56/001

(57) ABSTRACT

Apparatuses and methods for energy-efficient initial access for wireless systems. A method for a user equipment (UE) includes receiving a first downlink synchronization (DL-sync) signal on a cell, identifying, at least based on the first DL-sync signal, first parameters for transmission of a signal on the cell, and transmitting the signal on the cell based on the first parameters. The method further includes receiving a second DL-sync signal on the cell, identifying, based on the second DL-sync signal, second parameters for reception of a control channel that schedules reception of a system information block (SIB) for the cell, receiving the control channel on the cell based on the second parameters, and receiving the SIB on the cell.

### CROSS-REFERENCE TO RELATED AND CLAIM OF PRIORITY

The present application claims priority under 35 U.S.C. § 119(e) to U.S. Provisional Patent Application No. 63/651,903 filed on May 24, 2024, which is hereby incorporated by reference in its entirety.

### TECHNICAL FIELD

The present disclosure relates generally to wireless communication systems and, more specifically, the present disclosure is related to apparatuses and methods for energy-efficient initial access for wireless systems.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to energy-efficient initial access for wireless systems.

In one embodiment, a method for a user equipment (UE) is provided. The method includes receiving a first downlink synchronization (DL-sync) signal on a cell, identifying, at least based on the first DL-sync signal, first parameters for transmission of a signal on the cell, and transmitting the signal on the cell based on the first parameters. The method further includes receiving a second DL-sync signal on the cell, identifying, based on the second DL-sync signal, second parameters for reception of a control channel that schedules reception of a system information block (SIB) for the cell, receiving the control channel on the cell based on the second parameters, and receiving the SIB on the cell.

In another embodiment, a UE is provided. The UE includes a transceiver configured to receive a first DL-sync signal on a cell and a processor operably coupled with the transceiver. The processor configured to identify, at least based on the first DL-sync signal, first parameters for transmission of a signal on the cell. The transceiver is further configured to transmit the signal on the cell based on the first parameters and receive a second DL-sync signal on the cell. The processor is further configured to identify, based on the second DL-sync signal, second parameters for reception of a control channel. The control channel schedules reception of a SIB for the cell. The transceiver is further configured to receive the control channel on the cell based on the second parameters and receive the SIB on the cell.

In yet another embodiment, a base station comprising a transceiver configured to transmit a first DL-sync signal on a cell and a processor operably coupled with the transceiver, the processor configured to identify, at least based on the first DL-sync signal, first parameters for reception of a signal on the cell. The transceiver is further configured to receive the signal on the cell based on the parameters and transmit a second DL-sync signal on the cell. The processor is further configured to identify, based on the second DL-sync signal, second parameters for transmission of a control channel that schedules transmission of a SIB for the cell. The transceiver is further configured to transmit the control channel on the cell based on the second parameters and transmit the SIB on the cell.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrate an example of a wireless transmit and receive paths according to embodiments of the present disclosure; and

FIG. 5 illustrates an example method performed by a UE in a wireless communication system according to embodiments of the present disclosure.

### DETAILED DESCRIPTION

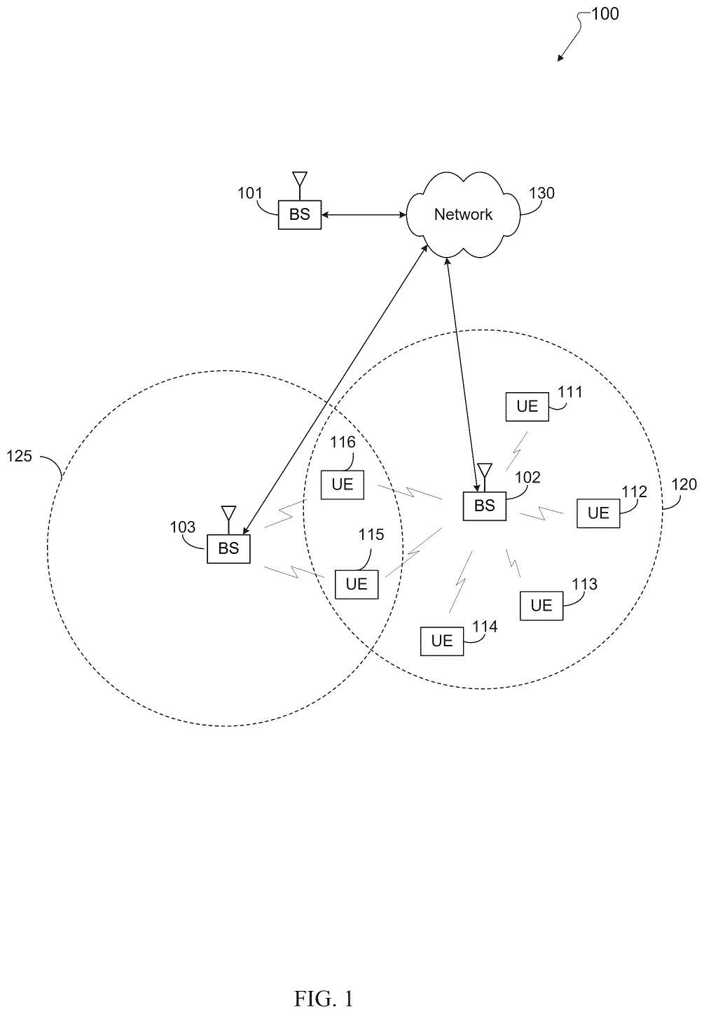

FIGS. 1-5, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation, radio access technology (RAT)-dependent positioning and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

The following documents and standards descriptions are hereby incorporated by reference into the present disclosure as if fully set forth herein: [REF 1]3GPP TS 38.211 Rel-18 v18.2.0, “NR; Physical channels and modulation;” [REF 2]3GPP TS 38.212 Rel-18 v18.2.0, “NR; Multiplexing and channel coding;” [REF 3]3GPP TS 38.213 Rel-18 v18.2.0, “NR; Physical layer procedures for control;” [REF 4]3GPP TS 38.214 Rel-18 v18.2.0, “NR; Physical layer procedures for data;” [REF 5]3GPP TS 38.215 Rel-18 v18.2.0, “NR; Physical layer measurements;” [REF 6]3GPP TS 38.321 Rel-18 v18.1.0, “NR; Medium Access Control (MAC) protocol specification;” [REF 7]3GPP TS 38.331 Rel-18 v18.1.0, “NR; Radio Resource Control (RRC) protocol specification;” [REF 8]3GPP TS 38.300 Rel-18 v18.1.0, “NR; NR and NG-RAN Overall Description; Stage 2;” and [REF 9]3GPP TS 38.304 Rel-18 v18.1.0, “NR; User Equipment (UE) procedures in Idle mode and in RRC Inactive state.”

FIGS. 1-3 below describe various embodiments implemented in wireless communications systems and with the use of orthogonal frequency-division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, longterm evolution (LTE), longterm evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for energy-efficient initial access for wireless systems. In certain embodiments, one or more of the gNBs 101-103 include circuitry, programing, or a combination thereof to provide for energy-efficient initial access for wireless systems.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

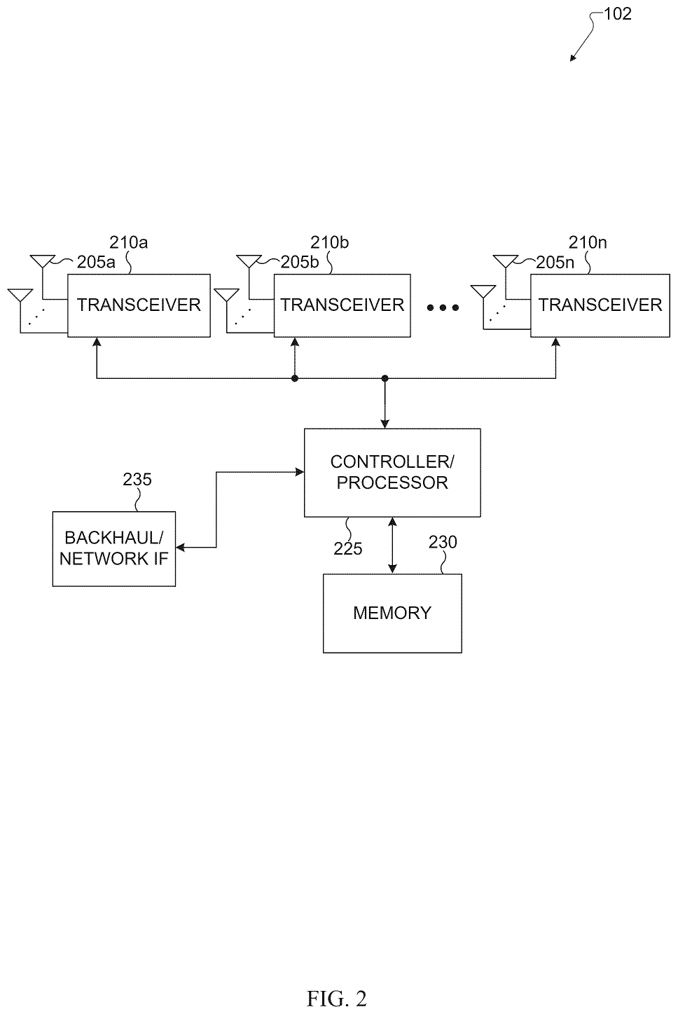

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-convert the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as providing for energy-efficient initial access for wireless systems. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The backhaul or network interface 235 could support communications over any suitable wired or wireless connection(s). For example, when the gNB 102 is implemented as part of a cellular communication system (such as one supporting 5G/NR, LTE, or LTE-A), the backhaul or network interface 235 could allow the gNB 102 to communicate with other gNBs over a wired or wireless backhaul connection. When the gNB 102 is implemented as an access point, the backhaul or network interface 235 could allow the gNB 102 to communicate over a wired or wireless local area network or over a wired or wireless connection to a larger network (such as the Internet). The backhaul or network interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

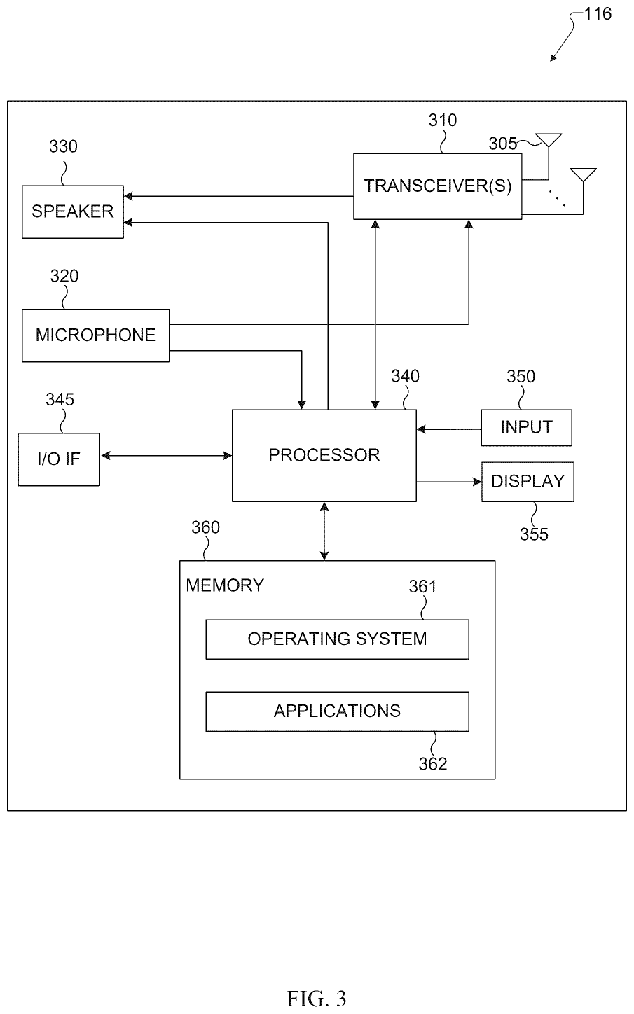

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the ULE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes to support energy-efficient initial access for wireless systems as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

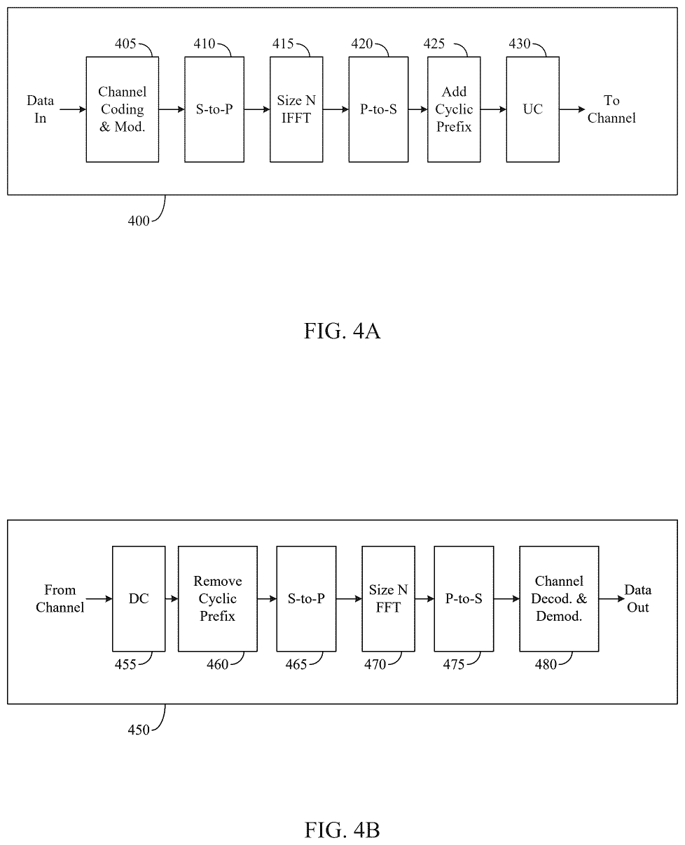

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 and/or the receive path 450 is configured for energy-efficient initial access for wireless systems as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

A communication system can include a downlink (DL) that refers to transmissions from a base station (such as the BS 102) or one or more transmission points to UEs (such as the UE 116) and an uplink (UL) that refers to transmissions from UEs (such as the UE 116) to a base station (such as the BS 102) or to one or more reception points.

A time unit for DL signaling or for UL signaling on a cell is referred to as a slot and can include one or more symbols. A symbol can also serve as an additional time unit. A frequency (or bandwidth (BW)) unit is referred to as a resource block (RB). One RB includes a number of sub-carriers (SCs). For example, a slot can have duration of 1 millisecond or 0.5 millisecond, include 14 symbols and an RB can include 12 SCs with inter-SC spacing of 15 kHz or 30 kHz, and so on.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. For brevity, a DCI format scheduling a PDSCH reception by a UE is referred to as a DL DCI format and a DCI format scheduling a physical uplink shared channel (PUSCH) transmission from a UE is referred to as an UL DCI format.

A gNB (such as the BS 102) transmits one or more of multiple types of RS including channel state information RS (CSI-RS) and demodulation RS (DM-RS). A CSI-RS is primarily intended for UEs to perform measurements and provide channel state information (CSI) to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process includes NZP CSI-RS and CSI-IM resources.

A UE (such as the UE 116) can determine CSI-RS transmission parameters through DL control signaling or higher layer signaling, such as radio resource control (RRC) signaling, from a gNB (such as the BS 102). Transmission instances of a CSI-RS can be indicated by DL control signaling or be configured by higher layer signaling. A DM-RS is transmitted only in the BW of a respective PDCCH or PDSCH and a UE can use the DM-RS to demodulate data or control information.

In certain embodiments, UL signals also include data signals conveying information content, control signals conveying UL control information (UCI), DM-RS associated with data or UCI demodulation, sounding RS (SRS) enabling a gNB to perform UL channel measurement, and a RA preamble enabling a UE to perform RA (see also NR specification). A UE transmits data information or UCI through a respective PUSCH or a physical UL control channel (PUCCH). A PUSCH or a PUCCH can be transmitted over a variable number of slot symbols including one slot symbol. The gNB can configure the UE to transmit signals on a cell within an active UL bandwidth part (BWP) of the cell UL BW.

UCI includes hybrid automatic repeat request (HARQ) acknowledgement (ACK) information, indicating correct or incorrect detection of data transport blocks (TBs) in a PDSCH, scheduling request (SR) indicating whether a UE has data in a buffer, and CSI reports enabling a gNB to select appropriate parameters for PDSCH or PDCCH transmissions to a UE. HARQ-ACK information can be configured to be with a smaller granularity than per TB and can be per data code block (CB) or per group of data CBs where a data TB includes a number of data CBs.

A CSI report from a UE can include a channel quality indicator (CQI) informing a gNB of a largest modulation and coding scheme (MCS) for the UE to detect a data TB with a predetermined block error rate (BLER), such as a 10% BLER (see NR specification), of a precoding matrix indicator (PMI) informing a gNB how to combine signals from multiple transmitter antennas in accordance with a MIMO transmission principle, and of a rank indicator (RI) indicating a transmission rank for a PDSCH.

UL RS includes DM-RS and SRS. DM-RS is transmitted only in a BW of a respective PUSCH or PUCCH transmission. A gNB can use a DM-RS to demodulate information in a respective PUSCH or PUCCH. SRS is transmitted by a UE to provide a gNB with an UL CSI and, for a time division duplexing (TDD) system, an SRS transmission can also provide a PMI for DL transmission. Additionally, in order to establish synchronization or an initial higher layer connection with a gNB, a UE can transmit a physical random-access channel (PRACH as shown in NR specifications).

In the following, unless otherwise noted, a parameter referenced in italics is provided by higher layers such as by RRC.

An antenna port is defined such that the channel over which a symbol on the antenna port is conveyed can be inferred from the channel over which another symbol on the same antenna port is conveyed.

For DM-RS associated with a PDSCH, the channel over which a PDSCH symbol on one antenna port is conveyed can be inferred from the channel over which a DM-RS symbol on the same antenna port is conveyed only if the two symbols are within the same resource as the scheduled PDSCH, in the same slot, and in the same precoding resource block group (PRG).

For DM-RS associated with a PDCCH, the channel over which a PDCCH symbol on one antenna port is conveyed can be inferred from the channel over which a DM-RS symbol on the same antenna port is conveyed only if the two symbols are within resources for which the UE may assume the same precoding being used.

For DM-RS associated with a physical broadcast channel (PBCH), the channel over which a PBCH symbol on one antenna port is conveyed can be inferred from the channel over which a DM-RS symbol on the same antenna port is conveyed only if the two symbols are within a synchronization signal/physical broadcast channel (SS/PBCH) block transmitted within the same slot, and with the same block index.

Two antenna ports are said to be quasi co-located if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters.

The UE (such as the UE 116) may assume that synchronization signal (SS)/PBCH block (also denoted as synchronization signal blocks (SSBs)) transmitted with the same block index on the same center frequency location are quasi co-located with respect to Doppler spread, Doppler shift, average gain, average delay, delay spread, and, when applicable, spatial Rx parameters. The UE may not assume quasi co-location for any other synchronization signal SS/PBCH block transmissions.

In absence of CSI-RS configuration, and unless otherwise configured, the UE may assume PDSCH DM-RS and SSB to be quasi co-located with respect to Doppler shift, Doppler spread, average delay, delay spread, and, when applicable, spatial Rx parameters. The UE may assume that the PDSCH DM-RS within the same code division multiplexing (CDM) group is quasi co-located with respect to Doppler shift, Doppler spread, average delay, delay spread, and spatial Rx. The UE may also assume that DM-RS ports associated with a PDSCH are quasi co-location (QCL) with QCL type A, type D (when applicable) and average gain. The UE may further assume that no DM-RS collides with the SS/PBCH block.

The UE can be configured with a list of up to M transmission configuration indication (TCI) State configurations within the higher layer parameter PDSCH-Config to decode PDSCH according to a detected PDCCH with DCI intended for the UE and the given serving cell, where M depends on the UE capability maxNumberConfiguredTCIstatesPerCC. Each TCI-State contains parameters for configuring a quasi-colocation (QCL) relationship between one or two downlink reference signals and the DM-RS ports of the PDSCH, the DM-RS port of PDCCH or the CSI-RS port(s) of a CSI-RS resource.

The quasi co-location relationship is configured by the higher layer parameter qcl-Type1 for the first DL RS, and qcl-Type2 for the second DL RS (if configured). For the case of two DL RSs, the QCL types may not be the same, regardless of whether the references are to the same DL RS or different DL RSs. The quasi co-location types corresponding to each DL RS are given by the higher layer parameter qcl-Type in QCL-Info and may take one of the following values: QCL-TypeA: {Doppler shift, Doppler spread, average delay, delay spread}; QCL-TypeB: {Doppler shift, Doppler spread; QCL-TypeC: {Doppler shift, average delay}; and QCL-TypeD: {Spatial Rx parameter}.

The UE receives a MAC-control element (CE) activation command to map up to [N] (e.g., N=8) TCI states to the codepoints of the DCI field “Transmission Configuration Indication.” When the HARQ-ACK corresponding to the PDSCH carrying the activation command is transmitted in slot n, the indicated mapping between TCI states and codepoints of the DCI field “Transmission Configuration Indication” may be applied after a MAC-CE application time, e.g., starting from the first slot that is after slot

$$( n + 3 {N}_{slot}^{subframe , μ} ) .$$

In some examples, the term ‘beam’ is used to refer to a spatial filter for transmission or reception of a signal or a channel. For example, a beam (of an antenna) can be a main lobe of the radiation pattern of an antenna array, or a sub-array or an antenna panel, or of multiple antenna arrays, sub-arrays or panels combined, that are used for such transmission or reception. In various examples, a beam such as a Tx beam or an Rx beam is referred to as a spatial filter, such as a spatial transmission filter or a spatial reception filter.

In the following and throughout the disclosure, various embodiments of the disclosure may be also implemented in any type of UE including, for example, UEs with the same, similar, or more capabilities compared to 5G NR UEs. Although various embodiments of the disclosure discuss 3GPP 5G NR communication systems, the embodiments may apply in general to UEs operating with other RATs and/or standards, such as next releases/generations of 3GPP, IEEE WiFi, and so on.

In the following, unless otherwise explicitly noted, providing a parameter value by higher layers includes providing the parameter value by master information block (MIB) or a system information block (SIB), such as a SIB1, or by a common RRC signaling, or by UE-specific RRC signaling.

In the following, for brevity of description, the higher layer provided TDD UL-DL frame configuration refers to tdd-UL-DL-ConfigurationCommon as example for RRC common configuration and/or tdd-UL-DL-ConfigurationDedicated as example for UE-specific configuration. The UE determines a common TDD UL-DL frame configuration of a serving cell by receiving a SIB such as a SIB1 when accessing the cell from RRC_IDLE or by RRC signaling when the UE is configured with SCells or additional secondary cell groups (SCGs) by an IE ServingCellConfigCommon in RRC_CONNECTED. The UE determines a dedicated TDD UL-DL frame configuration using the IE ServingCellConfig when the UE is configured with a serving cell, e.g., add or modify, where the serving cell may be the SpCell or an SCell of an master cell group (MCG) or secondary cell group (SCG). A TDD UL-DL frame configuration designates a slot or symbol as one of types ‘D’, ‘U’ or ‘F’ using at least one time-domain pattern with configurable periodicity.

In the following, for brevity of description, slot format indication (SFI) refers to a slot format indicator as example that is indicated using higher layer provided IEs such as slotFormatCombination or slotFormatCombinationsPerCell and which is indicated to the UE by group common DCI format such as DCI F2_0 where slotFormats are defined in [REF3].

The Synchronization Signal and PBCH block (SSB) includes primary and secondary synchronization signals (PSS, SSS), each occupying 1 symbol and 127 subcarriers, and PBCH spanning across 3 OFDM symbols and 240 subcarriers, but on one symbol leaving an unused part in the middle for SSS. The possible time locations of SSBs within a half-frame are determined by sub-carrier spacing and the periodicity of the half-frames where SSBs are transmitted is configured by the network (e.g., the network 130). During a half-frame, different SSBs may be transmitted in different spatial directions (i.e. using different beams, spanning the coverage area of a cell).

Within the frequency span of a carrier, multiple SSBs can be transmitted. The physical cell IDs (PCIs) of SSBs transmitted in different frequency locations do not have to be unique, i.e. different SSBs in the frequency domain can have different PCIs. However, when an SSB is associated with a remaining minimum system information (RMSI), the SSB is referred to as a Cell-Defining SSB (CD-SSB). A PCell is associated to a CD-SSB located on the synchronization raster.

Polar coding is used for PBCH. The UE (e.g., the UE 116) may assume a band-specific sub-carrier spacing for the SSB unless a network has configured the UE to assume a different sub-carrier spacing. PBCH symbols carry its own frequency-multiplexed demodulation reference signal (DMRS). QPSK modulation is used for PBCH.

Measurement time resource(s) for SSB-based reference signal received power (RSRP) measurements may be confined within a SSB Measurement Time Configuration (SMTC). The SMTC configuration provides a measurement window periodicity/duration/offset information for UE radio resource management (RRM) measurement per carrier frequency. For intra-frequency connected mode measurement, up to two measurement window periodicities can be configured. For RRC_IDLE, a single SMTC is configured per carrier frequency for measurements. For inter-frequency mode measurements in RRC_CONNECTED, a single SMTC is configured per carrier frequency. Note that if RSRP is used for L1-RSRP reporting in a CSI report, the measurement time resource(s) restriction provided by the SMTC window size is not applicable. Similarly, measurement time resource(s) for received signal strength indicator (RSSI) are confined within SMTC window duration. If no measurement gap is used, RSSI is measured over OFDM symbols within the SMTC window duration. If a measurement gap is used, RSSI is measured over OFDM symbols corresponding to overlapped time span between SMTC window duration and minimum measurement time within the measurement gap.

Link adaptation (AMC: adaptive modulation and coding) with various modulation schemes and channel coding rates is applied to the PDSCH. The same coding and modulation is applied to groups of resource blocks belonging to the same L2 protocol data unit (PDU) scheduled to one user within one transmission duration and within a MIMO codeword.

For channel state estimation purposes, the UE may be configured to measure CSI-RS and estimate the downlink channel state based on the CSI-RS measurements. The UE feeds the estimated channel state back to the gNB to be used in link adaptation.

Measurement reports are required to enable the scheduler to operate in both uplink and downlink. These include transport volume and measurements of a UEs radio environment.

Cell search is the procedure by which a UE acquires time and frequency synchronization with a cell and detects the Cell ID of that cell. NR cell search is based on the primary and secondary synchronization signals, and PBCH DMRS, located on the synchronization raster.

The Master Information Block (MIB) on PBCH provides the UE with parameters (e.g. CORESET #0 configuration) for monitoring of PDCCH for scheduling PDSCH that carries the System Information Block 1 (SIB1). PBCH may also indicate that there is no associated SIB1, in which case the UE may be pointed to another frequency from where to search for an SSB that is associated with a SIB1 as well as a frequency range where the UE may assume no SSB associated with SIB1 is present. The indicated frequency range is confined within a contiguous spectrum allocation of the same operator in which SSB is detected.

System Information (SI) includes a MIB and a number of SIBs, which are divided into Minimum SI and Other SI (OSI):
Minimum SI comprises basic information required for initial access and information for acquiring any other SI. Minimum SI includes:
   MIB contains cell barred status information and essential physical layer information of the cell required to receive further system information, e.g. CORESET #0 configuration. MIB is periodically broadcast on BCH.
   SIB1 defines the scheduling of other system information blocks and contains information required for initial access. SIB1 is also referred to as Remaining Minimum SI (RMSI) and is periodically broadcast on DL-SCH or sent in a dedicated manner on DL-SCH to UEs in RRC_CONNECTED.
Other SI (OSI) encompasses SIBs not broadcast in the Minimum SI. Those SIBs can either be periodically broadcast on DL-SCH, broadcast on-demand on DL-SCH (i.e. upon request from UEs in RRC_IDLE, RRC_INACTIVE, or RRC_CONNECTED), or sent in a dedicated manner on DL-SCH to UEs in RRC_CONNECTED (i.e., upon request, if configured by the network, from UEs in RRC_CONNECTED or when the UE has an active BWP with no common search space configured or when the UE configured with inter cell beam management is receiving DL-SCH from a TRP with PCI different from serving cell's PCI).

Paging allows the network to reach UEs in RRC_IDLE and in RRC_INACTIVE state through Paging messages, and to notify UEs in RRC_IDLE, RRC_INACTIVE and RRC_CONNECTED state of system information change and earthquake and tsunami warning system (ETWS)/commercial mobile alert system (CMAS) indications through Short Messages. Both Paging messages and Short Messages are addressed with paging radio network temporary identifier (P-RNTI) on PDCCH, but while the former is sent on paging control channel (PCCH), the latter is sent over PDCCH directly (see clause 6.5 of [REF 7]).

The random access procedure is triggered by a number of events:
Initial access from RRC_IDLE;
RRC Connection Re-establishment procedure;
DL or UL data arrival, during RRC_CONNECTED or during RRC_INACTIVE while SDT procedure (see clause 18.0) is ongoing, when UL synchronisation status is “non-synchronised”;
UL data arrival, during RRC_CONNECTED or during RRC_INACTIVE while SDT procedure is ongoing, when there are no PUCCH resources for SR available;
Handover;
SR failure;
Explicit request by RRC upon synchronous reconfiguration;
RRC Connection Resume procedure from RRC_INACTIVE;
To establish time alignment for a primary or a secondary TAG;
Request for Other SI (see clause 7.3);
Beam failure recovery;
Consistent UL listen-before-talk (LBT) failure on SpCell;
SDT in RRC_INACTIVE (see clause 18);
Positioning purpose during RRC_CONNECTED requiring random access procedure, e.g., when timing advance is needed for UE positioning;
Early UL synchronization with an L1/L2-triggered mobility (LTM) candidate cell;
RACH-based LTM cell switch.

Two types of random access procedure are supported: 4-step RA type with MSG1 and 2-step RA type with MSGA. Both types of RA procedure support contention-based random access (CBRA) and contention-free random access (CFRA).

The MSG1 of the 4-step RA type includes a preamble on PRACH. After MSG1 transmission, the UE monitors for a response from the network within a configured window. For CFRA, dedicated preamble for MSG1 transmission is assigned by the network and upon receiving random access response from the network, the UE ends the random access procedure. For CBRA, upon reception of the random access response, the UE sends MSG3 using the UL grant scheduled in the response and monitors contention resolution. If contention resolution is not successful after MSG3 (re)transmission(s), the UE goes back to MSG1 transmission.

The MSGA of the 2-step RA type includes a preamble on PRACH and a payload on PUSCH. After MSGA transmission, the UE monitors for a response from the network within a configured window. For CFRA, dedicated preamble and PUSCH resource are configured for MSGA transmission and upon receiving the network response, the UE ends the random access procedure. For CBRA, if contention resolution is successful upon receiving the network response, the UE ends the random access procedure; while if fallback indication is received in MSGB, the UE performs MSG3 transmission using the UL grant scheduled in the fallback indication and monitors contention resolution. If contention resolution is not successful after MSG3 (re)transmission(s), the UE goes back to MSGA transmission.

If the random access procedure with 2-step RA type is not completed after a number of MSGA transmissions, the UE can be configured to switch to CBRA with 4-step RA type.

For the random access procedure towards an LTM candidate cell for early UL TA acquisition, CFRA triggered by a PDCCH order is used. The UE sends MSG1 towards the cell without monitoring for a response from it. To support UE power ramping, the UE may perform MSG1 retransmission as indicated by the network.

For random access in a cell configured with supplementary uplink (SUL), the network can explicitly signal which carrier to use (UL or SUL). Otherwise, the UE selects the SUL carrier if and only if the measured quality of the DL is lower than a broadcast threshold. UE performs carrier selection before selecting between 2-step and 4-step RA type. The RSRP threshold for selecting between 2-step and 4-step RA type can be configured separately for UL and SUL. Once started, uplink transmissions of the random access procedure remain on the selected carrier.

The network can associate a set of RACH resources with feature(s) applicable to a Random Access procedure: Network Slicing (see clause 16.3), (e)RedCap (see clause 16.13), SDT (see clause 18), and NR coverage enhancement (see clause 19). A set of RACH resources associated with a feature is only valid for random access procedures applicable to at least that feature; and a set of RACH resources associated with several features is only valid for random access procedures having at least these features. The UE selects the set(s) of applicable RACH resources, after uplink carrier (i.e. normal uplink (NUL) or supplementary uplink (SUL)) and BWP selection and before selecting the RA type.

When CA is configured, random access procedure with 2-step RA type is only performed on PCell while contention resolution can be cross-scheduled by the PCell.

When CA is configured, for random access procedure with 4-step RA type, the first three steps of CBRA occur on the PCell while contention resolution (step 4) can be cross-scheduled by the PCell. The three steps of a CFRA started on the PCell remain on the PCell. CFRA on SCell can only be initiated by the BS to establish timing advance for a secondary TAG: the procedure is initiated by the BS with a PDCCH order (step 0) that is sent on an activated SCell of the secondary TAG, preamble transmission (step 1) takes place on the SCell, and Random Access Response (step 2) takes place on PCell.

When two TAG IDs are configured for the serving cell, the TAG for which the TA command is applied is indicated in Random Access Response message or in MSGB.

The following describes methods for PDSCH resource mapping.

When receiving the PDSCH scheduled with system information RNTI (SI-RNTI) and the system information indicator in DCI is set to 0, the LE shall assume that no SS/PBCH block, after puncturing if applicable, is transmitted in REs used by the UE for a reception of the PDSCH.

When receiving the PDSCH scheduled with SI-RNTI and the system information indicator in DCI is set to 1, random access RNTI (RA-RNTI), MSGB-RNTI, P-RNTI or temporary cell-radio network temporary identifier (TC-RNTI), the UE assumes SS/PBCH block transmission according to ssb-PositionsInBurst, and if the PDSCH resource allocation overlaps with physical resource blocks (PRBs) containing SS/PBCH block transmission resources the UE shall assume that the PRBs containing SS/PBCH block transmission resources, after puncturing if applicable, are not available for PDSCH in the OFDM symbols where SS/PBCH block is transmitted.

A UE expects a configuration provided by ssb-PositionsInBurst in ServingCellConfigCommon to be same as a configuration provided by ssb-PositionsInBurst in SIB1.

When receiving PDSCH scheduled by PDCCH with cyclic redundancy check (CRC) scrambled by cell-RNTI (C-RNTI), modulation and coding scheme C-RNTI (MCS-C-RNTI), configured scheduling RNTI (CS-RNTI), group RNTI (G-RNTI), group configured scheduling RNTI (G-CS-RNTI), multicast control channel RNTI (MCCH-RNTI), multicast-MCCH-RNTI or PDSCHs with semi-persistent scheduling (SPS), the REs corresponding to the configured or dynamically indicated resources in Clauses 5.1.4.1, 5.1.4.2 are not available for PDSCH. Furthermore, the UE assumes SS/PBCH block transmission according to ssb-PositionsInBurst if the PDSCH resource allocation overlaps with PRBs containing SS/PBCH block transmission resources, after puncturing if applicable, and the UE shall assume that the PRBs containing SS/PBCH block transmission resources, after puncturing if applicable, are not available for PDSCH in the OFDM symbols where SS/PBCH block associated with the same PCI is transmitted.

A UE is not expected to handle the case where PDSCH DM-RS REs are overlapping, even partially, with any RE(s) not available for PDSCH.

For operation with shared spectrum channel access, SS/PBCH block transmission according to ssb-PositionsInBurst represents the candidate SS/PBCH blocks corresponding to SS/PBCH block indices provided by ssb-PositionsInBurst as described in Clause 4.1 of [REF 3].

The following UE procedures apply at least to activation/deactivation of SS/PBCH block transmissions on a secondary cell.

A UE can be indicated, by od-ssb-config [TS 38.331] or by a first MAC CE [TS 38.321], activation of transmission for SS/PBCH blocks in a configured DL BWP of an SCell [TS 38.300]. The UE can be indicated, by a third MAC CE, adaptation of parameters for the activated transmission of SS/PBCH blocks when the SCell is activated. A number of half frames with transmission of SS/PBCH blocks is indicated by the first or third MAC CE from values provided by od-ssb-nrofBurst, if provided; otherwise, the transmission of the SS/PBCH blocks occurs until it is deactivated by a second MAC CE [TS 38.321], where
the physical cell identity of the SS/PBCH blocks is indicated by od-ssb-physCellId, if provided; otherwise, by physCellId in ServingCellConfigCommon
the indexes of transmitted SS/PBCH blocks are indicated by the first or the third MAC CE from candidate values provided by od-ssb-PositionsInBurst, if provided; otherwise, by ssb-PositionsInBurst
the frequency location of the SS/PBCH blocks is indicated by od-absoluteFrequencySSB, if provided; otherwise, by absoluteFrequencySSB
the SCS configuration of the SS/PBCH blocks is indicated by od-ssbSubcarrierSpacing, if provided; otherwise, by ssbSubcarrierSpacing
the power of the SS/PBCH blocks is indicated by od-ss-PBCH-BlockPower, if provided; otherwise, by ss-PBCH-BlockPower
the periodicity of the transmission of the SS/PBCH blocks are indicated by the first or third MAC CE from candidate values by od-ssb-Periodicity
the half frames for the transmission of the SS/PBCH blocks are determined based on an indication by the first or third MAC CE
the transmission of the SS/PBCH blocks is in frames with a system frame number (SFN) determined from (SFN+SFN_offset)·10 mod P=0, where P is the periodicity for the transmission of the SS/PBCH blocks, and SFN_offset is the indicated SFN offset by the first or third MAC CE from candidate values by od-ssb-sfn-Offset, if provided; else, SFN_{offset}=0. An index of a half frame with transmission of the SS/PBCH blocks in a corresponding frame is indicated by the first or third MAC CE from candidate values by od-ssb-halfFrameIndex, if provided; else the index is 0

When the activation or adaptation of the SS/PBCH blocks transmission is by the first or the third MAC CE, respectively, and with reference to slots of a configured DL BWP for the SS/PBCH blocks transmission, the UE expects that the transmission of the SS/PBCH blocks according to the indicated parameters starts from a first slot including the candidate SS/PBCH block occasion corresponding to the first transmitted SS/PBCH block index and located in a first half frame within the half frames for the transmissions of the SS/PBCH blocks, that is at least

$$m + 3 {N}_{slot}^{subframe , μ} + 1$$

slots after slot n, where n is a slot when a PDSCH reception providing the first or the third MAC CE ends, respectively, n+m is a slot indicated for PUCCH transmission with HARQ-ACK information for the PDSCH reception as described in clause 9.2.3, and Nₛₗₒₜ^{subtrame,μ} is a number of slots per subframe for the SCS configuration μ of the PUCCH transmission as defined in [4, TS 38.211]. For example, the first MAC-CE and the third MAC-CE can be a same MAC-CE.

When the activation of transmission for the SS/PBCH blocks is by od-ssb-config, the UE expects that the transmission of the SS/PBCH blocks starts at the next half frame with transmission of the SS/PBCH blocks.

When the deactivation of the SS/PBCH blocks transmission is by the second MAC CE, and with reference to slots of the configured DL BWP for the SS/PBCH blocks transmission, the UE expects that the transmission of the SS/PBCH blocks according to the indicated parameters terminates from
a slot n+T, if the slot n+T is not within a first slot to a last slot with activated transmission of SS/PBCH blocks in a half frame, where

$$T = m + 3 {N}_{slot}^{subframe , μ} + 1 ,$$

n is a slot when a PDSCH reception providing the second MAC CE ends, n+m is a slot indicated for PUCCH transmission with HARQ-ACK information for the PDSCH reception as described in clause 9.2.3, and

$${N}_{slot}^{subframe , μ}$$

is a number of slots per subframe for the SCS configuration μ of the PUCCH transmission as defined in [4, TS 38.211]
the first slot including the candidate SS/PBCH block corresponding to the last transmitted SS/PBCH block index that is not earlier than the slot n+T, if the slot n+T is within a first slot to a last slot with activated transmission of SS/PBCH blocks in a half frame

When the UE is not provided absoluteFrequencySSB for the SCell, the UE does not expect the transmission of the SS/PBCH blocks provided by od-ssb-config to be deactivated while the SCell is activated.

When a first SS/PBCH block in a configured DL BWP can be used to obtain SIB1 and a frequency location of the first SS/PBCH block, provided by absoluteFrequencySSB, corresponds to the GSCN of a synchronization raster entry, the UE expects:
a frequency location of a second SS/PBCH block, provided by od-absoluteFrequencySSB, to be different from the frequency location of the first SS/PBCH block and not to correspond to the GSCN of a synchronization raster entry
frequency resources of the second SS/PBCH block not to overlap with frequency resources of the first SS/PBCH block
the second SS/PBCH block to be within the configured DL BWP as the first SS/PBCH block

When a first SS/PBCH in a configured DL BWP cannot be used to obtain SIB1, the UE expects
a same frequency location for a second SS/PBCH block, provided by od-ssb-config, and for the first SS/PBCH block, provided by absoluteFrequencySSB
a same PBCH payload, other than the SFN index and the half frame index, for the first SS/PBCH block and for the second SS/PBCH block with same SS/PBCH block index as the first SS/PBCH block

The UE may assume that a first SS/PBCH block with center frequency provided by absoluteFrequencySSB and a second SS/PBCH block provided by od-ssb-config are quasi co-located with respect to Doppler shift, Doppler spread, average gain, average delay, delay spread and, when applicable, spatial RX parameters, when they have a same SS/PBCH block index.

The following UE procedures apply to request of SIB1 reception. Unless otherwise mentioned, the higher layer parameters in the following procedures can be provided by SIB1-RequestConfig on a first cell.

A UE can be provided, by NES_CellId, a physical cell identity of a second cell and an ARFCN by ARFCN-ValueNR for SS/PBCH block receptions on the second cell. When
the UE receives an SS/PBCH block on the second cell, and
k_{SSB}>23 for FR1 or k_{SSB}>11 for FR2 is indicated by the SS/PBCH block on the second cell, and
conditions for PRACH transmission associated with the SS/PBCH block on the second cell are satisfied [TS 38.331],
   the UE can transmit a PRACH associated with the SS/PBCH block on the second cell based on:
a timing adjustment indicated by n-TimingAdvanceOffset, if provided, as described in Clause 4.2
a power determined as described in Clause 7.4
a procedure determined as in Clause 8.1 based on Type-1 random access procedure
   where k_{SSB} for determining the common resource block [TS 38.211] is provided by k-ssb.

In response to the PRACH transmission, the UE monitors PDCCH on the second cell to detect a DCI format 1_0 with CRC scrambled by a corresponding RA-RNTI during a window controlled by ra_ResponseWindow, as described in Clause 8.2 of [TS 38.213]. The UE monitors PDCCH according to a Type1-PDCCH CSS set provided by ra-SearchSpace, if provided; else provided by SearchSpaceZero as described in Clause 10.1 of [TS 38.213].

If the UE identifies a RAPID associated with a corresponding PRACH transmission from the UE in a PDSCH reception scheduled by the DCI format 1_0 with CRC scrambled by the RA-RNTI, the UE can be indicated by higher layers to monitor PDCCH on the second cell to detect a DCI format 1_0 with CRC scrambled by the SI-RNTI according to a Type0-PDCCH CSS set provided by SearchSpaceZero. If the UE is provided by a corresponding UE capability, the UE monitors PDCCH only in monitoring occasions associated with the SS/PBCH block. The UE starts monitoring PDCCH to detect the DCI format 1_0 with CRC scrambled by the SI-RNTI after a number of slots provided by od-sib1-windowStartOffset from the starting slot of the window controlled by ra_ResponseWindow, and for a number of slots provided by od-sib1-WindowDuration.

The UE is not required to monitor PDCCH on the second cell to detect the DCI format 1_0 with CRC scrambled by the SI-RNTI prior to a reception of a PDSCH scheduled by the DCI format 1_0 with CRC scrambled by the RA-RNTI. Such UE procedure can be conditioned on the SS/PBCH block on the second cell indicates k_{SSB}>23 for FR1 or k_{SSB}>11 for FR2.

The following UE procedures can apply at least to Periodicity adaptation for reception of SS/PBCH blocks on a secondary cell.

A UE can be provided, by addl-ssb-Periodicity, a set of periodicities for reception of SS/PBCH blocks on an SCell. The SS/PBCH blocks do not include an SS/PBCH block that the UE can use to obtain SIB1 for the SCell.

The UE can be additionally provided, by dci-Format2-9, a Type3-PDCCH CSS set to monitor PDCCH for detection of DCI format 2_9 with CRC scrambled by a ssbPeriodicityIndication-RNTI as described in clause 10.1, and a location in DCI format 2_9 by positionInDCI-ssbPeriod an SS/PBCH block reception periodicity indication field for the SCell [TS 38.212].

When a UE receives in slot m on the active DL BWP of a first serving cell a PDCCH providing DCI format 2_9 that indicates a change in periodicity for reception of SS/PBCH blocks on a second serving cell, the UE expects that the transmission of SS/PBCH blocks according to the indicated periodicity on the second serving cell starts from a slot on the second serving cell that includes the candidate SS/PBCH block occasion corresponding to the first transmitted SS/PBCH block provided by ssb-PositionsInBurst in a half frame and does not begin before the beginning of slot m+d on the active DL BWP of the first serving cell, where d is a number of slots for the SCS of the active DL BWP of the first serving cell in a predetermined Table.

Various wireless systems, including 5G NR, are based on periodic and always-on (e.g., non-configurable or non-mutable or non-adjustable) signals or channels, such as NR SSB or CORESET #0 or Type-0 PDCCH or other common control such as Type-0A/1/1A/2/2A PDCCH, that are widely used for initial access, synchronization, system information acquisition, connection establishment, and mobility management. For example, for initial access, the UE assumes that the SSB is transmitted in any cell with a 20 msec periodicity.

In addition, various wireless systems, such as 5G NR, are designed based on periodic transmission of system information, including the minimum system information or master information block (MIB), or the remaining minimum system information (RMSI), also referred to as SIB1. For example, MIB or SIB1 are transmitted every SSB periodicity.

Such periodic and always-on transmissions that are not configurable/adjustable/mutable by the network consume material energy.

Therefore, embodiments of the present disclosure recognize that there is a need to design energy-efficient mechanisms for energy-efficient initial access, synchronization, system information acquisition, connection establishment, and mobility management.

Embodiments of the present disclosure further recognize that there is also a need to enable a network/BS to adjust or turn off (mute) a signal or channel used for synchronization and initial access, as well as MIB or SIB1, based on network decision, cell load, or traffic situation.

The present disclosure provides methods and apparatus to support energy-efficient initial access.

One consideration for network energy saving (NES) or for UE power saving (UEPS) can be to avoid unnecessary energy/power consumption, as long as the intended procedures and functionalities are not impacted. For example, when there is no UE present in a cell (or in a neighbor cell or in a corresponding cell group), limited or no transmission or receptions of UL/DL signals or channels may be necessary. For example, when mostly/only INACTIVE or IDLE UEs are present in a cell (or in a neighbor cell or in a corresponding cell group), limited transmissions or receptions, such as for paging or paging early indication (PEI) or small data transmission (SDT) may be sufficient, and other signals or channels can be disabled or not transmitted or received. For example, when one or a number of CONNECTED mode UEs are present in a cell (or in a neighbor cell or in a corresponding cell group), various signals or channels may be transmitted or received with partial or full coordination, in time/frequency/spatial/code/power domains, between the UE and the gNB to improve the energy/energy efficiency.

The embodiments may apply to any deployments, verticals, or scenarios including in FR1, FR2, FR3, FR4, with enhanced mobile broadband (eMBB), ultra reliable low latency communications (URLLC) and industrial internet of things (IIoT), massive machine-type communications (mMTC) and internet of things (IoT) including LTE narrowband (NB)-IoT or NR IoT or Ambient IoT (A-IoT), with AI/ML operation, with sidelink/V2X communications, in unlicensed/shared spectrum (NR-U), for non-terrestrial networks (NTN), for aerial systems such as unmanned aerial vehicles (UAVs) such as drones, for private or non-public networks (NPN), for operation with reduced capability (RedCap) UEs, multi-cast broadcast services (MBS), with integrated sensing and communication (ISAC) operation, and so on.

Embodiments of the disclosure are summarized in the following and are fully elaborated further herein. Combinations of the embodiments are also applicable but are not described in detail for brevity.

In one embodiment, a cell, such as a 6G PCell, can operate based on a master information block (MIB) that is provided by an SSB (such as an existing SSB, as in 5G, or a modified SSB), and based on a SIB1 transmission that can be activated or deactivated on the cell. The MIB can include a flag (or can provide other explicit signaling or implicit indication such by PHY parameter selection of SSB) to indicate whether SIB1 is activated or that cell is in a non-NES mode or indicates that SIB1 is deactivated on the cell or that the cell is in a network energy saving (NES) mode.
When the flag indicates a non-NES mode or that SIB1 is activated on the cell or when the BCCH has a first message type associated with MIB, the UE interprets the PBCH contents/MIB fields to provide first information for synchronization or SIB1 PDCCH parameters, such as CORESET #0 and SS #0. The UE can proceed to synchronize, receive the SIB1 PDCCH/PDSCH, and operate as intended, such as camping on the cell, performing initial/random access and RRC connection establishment with the cell, or performing RRM measurements on the cell.
When the flag indicates an NES mode or that SIB1 is deactivated on the cell or when the BCCH has a second message type associated with UL WUS, the UE interprets the PBCH contents/MIB fields to provide second information for (a simplified/compact) configuration of an uplink network-wake-up signal or channel (referred to as ‘UL wake up signal (WUS)’, for brevity), such as an ‘initial’ PRACH or a ‘cell-specific’ UL SRS or a ‘cell-specific’ PUCCH. The second information can include information of PHY parameters for generation of the UL WUS, time/frequency (T/F) resources thereof, such as number of OFDM symbols or REs/RBs, or placement of the T/F resources as offset values relative to T/F resources for the SSB.
   When SIB1 is deactivated on the cell or cell is in NES mode, the UE can transmit the UL WUS to request for reception of SIB1. The first information can indicate a single T/F resource for the UL WUS, and the UE can transmit the UL WUS in a same T/F resource regardless of an SSB time index or an associated spatial transmission/reception filter. Alternatively, the first information can indicate multiple T/F resources for the UL WUS, and the UE can transmit the UL WUS in a T/F resource, from the multiple T/F resources, associated with an SSB time index or an associated spatial transmission/reception filter that the UE detects on the cell (and may determine for a subsequent camping on the cell or for a subsequent initial/random access or for RRM measurement).
   Once the gNB receives the UL WUS, the gNB can activate (i.e., can start transmitting) the SIB1 on the cell, and can update the MIB flag or the message class/type for BCCH to indicate that SIB1 is activated or that the cell is in non-NES mode. The UE attempts to receive the PDCCH for SIB1 based on SIB1 PDCCH configuration included in the first information provided by a next instance of SSB (with the MIB flag or the BCCH message class/type then indicating SIB1 activated), or by reinterpreting MIB in a previous SSB instance (which had the MIB flag or BCCH message class/type indicating SIB1 as deactivated or the cell as in NES mode) as if it had provided the first information. Alternatively, the UE may receive SIB1 configuration information, such as information for CORESET #0 or SS #0, in a wake-up response, such as a random-access response (RAR), that the UE receives in response to the transmission of the UL WUS. For example, the UE receives the RAR in a CORESET and search space, such as CORESET #0 and SS #0, for which the information is predetermined in the specifications of system operation, or provided by OAM, or provided by the PBCH. In next occasions of SSB transmission, the gNB can provide updated MIB information, such as updated flag value to indicate that SIB1 is activated/cell is in non-NES mode, or updated first information for SIB1 PDCCH configuration (if needed).
   The gNB (e.g., the BS 102) can deactivate the SIB1 on the cell, based on gNB implementation, such as based on a gNB-side inactivity timer/event, for example, no UL transmission on the cell for a time duration larger than a certain threshold, or based on UE assistance information, such as UE indication of no UL traffic (similar to a buffer status report ‘BSR” or an variant thereof) or that the UE can be released. When the gNB deactivates the SIB1 on the cell, the MIB flag or the BCCH message class/type can be updated to indicate that SIB1 is deactivated on the cell or cell is switched to NES mode, and the MIB will provide second information for UL WUS configuration. The MIB can provide same or different information for UL WUS in different periods/durations when SIB1 is deactivated.
   It is noted that, a transmission of the UL WUS, such as the ‘initial’ PRACH transmission, may not be (necessarily) for the purpose of establishing RRC connection, and instead can be for the purposes of requesting on-demand SIB1 on the cell. Once the UE receives the activated/on-demand SIB1, the UE can proceed to establishing RRC connection (for example, as in 4G/5G), such as by determining a full RA configuration for establishing RRC connection, and performing a 4-step or 2-step RACH operation.
When MIB includes a cellBarred field with value ‘barred’ and the MIB flag indicates that the cell is deactivated, in one example, the UE may not attempt to request for SIB1 by transmitting the UL WUS, possibly except for certain UE types, such as RedCap UEs, NTN UEs, or UEs with prioritized access, and so on, as predetermined in the specifications of system information. The UE can proceed, for example (as in 5G NR), to access a different cell in the same frequency band or in a different frequency band based on the value of an intraFreqReselection field in the MIB. In another example, the UE does not expect PBCH to provide information of UL WUS when the MIB indicates a cellBarred field with value ‘barred’. In another example, when the PBCH provides information of UL WUS parameters, the UE discards/ignores a values of cellBarred field in the MIB, regardless of indicating a with value ‘barred’ or ‘notBarred’, and attempts to transmit the UL WUS.

For example, MIB may not include an explicit IE for the flag within MIB/PBCH, and other options may be used, such as having the flag value as a sequence parameter (such as scrambling parameter or frequency/RB-level/RE-level offset, and so on) or partitioning of PSS/SSS sequences. In another example, there may be no indication for the flag, and the UE may determine, for example based on UE implementation, whether or not the UE can receive the SIB1 PDCCH.

In yet another example, PBCH can include a message class indicator that takes on different values to indicate different purposes or interpretations of PBCH. For example, a first value of the message class for PBCH can be ‘MIB’ and a second value of the message class for PBCH can be ‘WUS’ or ‘UL WUS’. For example, the BCCH-BCH-Message class is the set of RRC messages that may be sent from the network to the UE via BCH on the BCCH logical channel. For example,

BCCH-BCH-Message ::= SEQUENCE { message BCCH-BCH-MessageType }
BCCH-BCH-MessageType ::= CHOICE { mib MIB, ul-wus UL-WUS, messageClassExtension
SEQUENCE { } }

For example, modified SSB can refer to an SSB design based on different sequence, different T/F allocation, different periodicity, with or without PBCH, and so on. For example, modified SSB can refer to PSS only, or SSS only, or PSS+SSS only without PBCH, including 1-symbol PSS+SSS or 2-symbol PSS+SSS, with or without any of the previously described modifications. For example, modified SSB can be based on different modulation from 5G NR, such as modified OFDM modulation, or OOK/FSK/PSK-based modulation, and so on.

For example, MIB can include M bits, such as M bits, for example, M≥24 bits, with the first bit being a 1-bit SIB1Activation field (or cellActivation field) or cell operation mode such as NES mode or non-NES mode.

PBCH/BCCH/MIB interpretation when SIB1 is activated: When a message class/type of BCCH or a field for cell operation mode in PBCH/MIB such as SIB1Activation provides a value ‘activated’ or non-NES mode (or 1), the UE interprets the MIB to include a first set of fields, for example, as follows, with fields as previously described (some fields or field sizes can be different from the following, or some fields may not be present, or some additional fields may be included):

| | |
|---|---|
| MIB ::= | SEQUENCE { |
| SIB1Activated | ENUMERATED {activated}, |
| systemFrameNumber | BIT STRING (SIZE (6)), |
| subCarrierSpacingCommon | ENUMERATED {scs15or60, scs30or120}, |
| ssb-SubcarrierOffset | INTEGER (0..15), |
| dmrs-TypeA-Position | ENUMERATED {pos2, pos3}, |
| pdcch-ConfigSIB1 | PDCCH-ConfigSIB1, |
| cellBarred | ENUMERATED {barred, notBarred}, |
| intraFreqReselection | ENUMERATED {allowed, notAllowed}, |
| spare | BIT STRING (SIZE (S1)) |

}

For example, MIB includes information about relative or absolute T/F resource of the SSB, SIB1 PDCCH configuration, or cell access information. For example, S1=0, and no spare field exists in the MIB. For example, S1>0, at least when PBCH includes larger payload, such as when more RBs are included for PBCH or for the entire SSB. For example, when MIB periodicity is larger, such as 320 msec or 640 msec, the systemFrameNumber field can include fewer bits, such as 10-5=5 or 10-6=4 bits in the MIB (with the remaining 5 bits or 6 bits, respectively, provided as payload of PBCH).

For example, when a message class/type of BCCH or a field for cell operation mode in PBCH/MIB such as SIB1Activation indicates ‘activated’ or a cell operation mode as non-NES, the UE may assume a first SSB periodicity at least for initial access, such as 20 msec. For example, the actual SSB periodicity can be same as first SSB periodicity, or can be up to the gNB implementation, such as a value from the set {5, 10, 20, 40, 60, 80, 160, 240, 320, 640} or a subset or variation thereof. For example, MIB is transmitted on the cell with a first MIB periodicity, such as 80 msec, and may be repeated one or more times within the first MIB periodicity, such as every (actual or assumed) SSB periodicity. For example, when SIB1Activation indicates ‘activated’ or cell operation mode is indicated as non-NES, SIB1 is transmitted on the cell with a periodicity, such as 160 msec, and may be repeated one or more times within the SIB1 periodicity, such as every 20 msec or every (actual or assumed) SSB periodicity.

It is noted that, when SIB1Activation indicates ‘activated’ for a cell or cell operation mode is indicated as non-NES, PBCH can provide further information about the cell outside the MIB (for example, by scrambling patterns of PBCH), such as the following:
4 least significant bits (LSBs) of SFN;
Half-radio-frame timing bit;
3 most significant bits (MSBs) of SSB index (for FR2) or possibly 1-2 MSBs of SSB index (for FR3);
1 bit of k_SSB (for FR1 or possibly for FR3).

MIB interpretation when SIB1 is deactivated or when cell operation mode indicates NES mode: When a message class/type of BCCH or a field for cell operation mode in PBCH/MIB such as SIB1Activation provides a value ‘deactivated’ or a cell operation in NES mode (or 0), the UE interprets the PBCH/MIB to include a second set of fields, for example, as follows (some fields or field sizes can be different from the following, or some fields may not be present, or some additional fields may be included):

| | |
|---|---|
| MIB ::= | SEQUENCE { |
| cellActivated | ENUMERATED {deactivated}, |
| ul-wus-ConfigSIB1 | UL-WUS-ConfigSIB1, |
| cellBarred | ENUMERATED {barred, notBarred}, |
| intraFreqReselection | ENUMERATED {allowed, notAllowed}, |
| spare | BIT STRING (SIZE (S2)) |

}

For example, when the UL WUS is a PRACH transmission, a compact configuration for the UL WUS UL-WUS-ConfigSIB1 can include a number of bits, for example >20 bits, such as the following fields (wherein values x and y are predetermined in the specifications), with details as subsequently described:

| | |
|---|---|
| UL-WUS-ConfigSIB1 ::= | SEQUENCE { |
| resource-Config-WUS | INTEGER (0..x), |
| Tx-Config-WUS | INTEGER (0..y), |

}

When the specification of system operation supports for RAR reception in response to the UL WUS transmission, or when the cell indicates (e.g., by a flag in UL-WUS-ConfigSIB1) a support for RAR in response to UL WUS (such as by a flag ‘RAR-for-WUS’ with values ‘support’), the configuration UL-WUS-ConfigSIB1 can additionally include Is for configuration of a CORESET and a search space set, such as CORESET #0 and SS #0, for such RAR reception.

For example, resource-Config-WUS can provide first parameters for PRACH preamble generation, and second parameters for T/F resource of the UL WUS, such as the number of OFDM symbols, and number of RBs/REs, or placement of the T/F resources for the ‘initial’ PRACH as an UL WUS; and Tx-Config-WUS can provide third parameters for transmission-related parameters and any potential follow-up procedures.

For example, UL-WUS-ConfigSIB1 may include the parameters listed in Table_1.

TABLE 1
configuration parameters (UL-WUS-ConfigSIB1) for PRACH as UL WUS

| Parameter | Note |
|---|---|
| SCS for PRACH resource allocation | Provided by |
| (Δf) | subCarrierSpacingCommon; |
| | Time-domain and frequency-domain |
| | allocations, including offsets, are |
| | based on this SCS value. Alternatively, |
| | is used as SCS for common channels, |
| | and an SCS for PRACH can be |
| | provided as a separate parameter or |
| | can be predetermined or |
| | preconfigured. |
| PRACH preamble format | Jointly encode the PRACH preamble |
| Time-domain (symbol/slot) offset | format & the time-domain offset |
| relative to a reference SSB index (e.g., | values. Different offset values for |
| with respect to the first symbol of SSB | different PRACH preamble formats |
| index #0 or the last actually transmitted | (similar to the tables for prach- |
| | ConfigurationIndex); |
| SSB, or the last possible SSB index in | Limited values for symbol offset, e.g., |
| the corresponding frequency | from {0, ±1, ±2, [±3]} symbols; |
| band/range, or any detected SSB) | Limited small values for slot offset, |
| | e.g., {1, 2} slots after SSB burst, or the |
| | first UL slot of the TDD pattern; |
| | Slot-group-level granularity or offset to |
| | handle (DL-heavy) TDD patterns; |
| | Inter-RO gap or pattern in case of |
| | multiple ROs for UL WUS can be a |
| | separate parameter that can be also |
| | jointly coded with other time-domain |
| | parameters. |
| | Can also jointly encode the reference |
| | index and the time-domain parameters. |
| Frequency-domain (RE/RB/RBG) | RE offset similar to a subset of values |
| offset relative to a reference SSB index | for k_SSB; |
| | Few negative or positive RB offset |
| | values, e.g., from {0, ±2, ±4, ±6, ±8, |
| | ±12}, (similar to CORESET #0 |
| | configuration); |
| | RBG offset only for FDD bands with |
| | RBG size from the set {1, 4, 8, 16} RBs |
| FDM′ed ROs (msg1-FDM) | from the set {1, 2, 4, 8} as in 5G NR, or |
| | a subset thereof, or disable/no FDM, |
| | or all are FDM for increased NES (for |
| | example, when the gNB can handle |
| | multiple beams) |
| SSB-to-RO association (ssb- | A subset of 5G NR configuration, e.g., |
| perRACH-OccasionAndCB- | only N ≥ 1 SSBs per RO, i.e., {1, 2, 4, |
| PreamblesPerSSB) | 8, 16}, or disable (N = 1, one RO per |
| | SSB index); |
| | Only one PRACH preamble per SSB |
| RSRP threshold for SSB selection | [4] values for extended RSRP ranges, |
| (rsrp-ThresholdSSB) | e.g., |
| | $ext\_RSRP \_Range = ⌊ \frac{RSRP\_Range}{32} ⌋$ |
| UL power control parameters for UL | Jointly encode SSB Tx power, PRACH |
| WUS | target Rx power, and max #Tx for |
| | PRACH |
| | (ss-PBCH-BlockPower, |
| | preamble ReceivedTargetPower, |
| | preamble TransMax); |
| Maximum number of transmissions | The power ramp-up step |
| | (powerRampingStep) can be also |
| | jointly encoded with the above |
| | parameters, or can be a separate |
| | parameter. |
| | The emission power value (p-Max) can |
| | be a separate parameter, with reduced |
| | range. |

A simplified table for UL WUS configuration can be as in Table 2.

TABLE 2
configuration parameters (UL-WUS-
ConfigSIB1) for PRACH as UL WUS

| | Payload |
|---|---|
| UL WUS field | (bits) |
| Time-frequency offset to SSB/LP-SS (e.g., same | 3-4 |
| starting RB in TDD, or next slot in FDD) | |
| T/F granularity (including TDD DL-UL gap of 5 to | 2-4 |
| 160 slots, or FDD duplex gap of ~30 to ~190 MHz) | |
| SSB-to-UL_WUS association (including FDM'ed | 0-3 |
| UL-WUS . . . contention is possible.) | |
| RSRP threshold for SSB/LP-SS selection | 0-2 |
| Power control parameters (Rx power for UL WUS, | 5-9 |
| Tx power for SSB/LP-SS, 4-8 dB granularity) | |
| (UL WUS ReTx power ramping, Max # ReTx → can | |
| be included or can be absent) | |
| Emission power p-Max (with 4-8 dB granularity) | 4-5 |
| Total | 19-27 |

It is noted that UL-WUS-ConfigSIB1 can include additional fields, or may exclude some of the following fields or can include variations or combinations of the following fields. One or more of the first parameters are jointly encoded and provided with one or more of the second parameters, and so on. Certain parameters can be jointly encoded into codepoints that provide combinations of parameters, or can be separately provided. In addition, some of the information fields or some bits of one or more fields can be provided by PBCH payload outside the MIB, such as by scrambling patterns of the PBCH and so on. For example, the following information may not be provided by PBCH, and other information can be indicated instead:
4 LSBs of SFN;
Half-radio-frame timing bit;
1 bit of k_SSB (for FR1).

In one example, PBCH fields that can be repurposed include:
At least, fields for frame-level sync & SIB1 scheduling→20 bits
Possibly also, fields for SSB index and k_SSB→7 more bits
Total: 20 to 27 bits.

To fit the UL WUS info into LP-SS, additional designs are needed, such as increased resource usage or an additional LP-PBCH or LP-WUS attached to or associated with LP-SS.

For example, only symbol-level synchronization may be sufficient for UL WUS transmission, and frame-level synchronization may not be needed. Therefore, IEs such as SFN (in the MIB or in the PBCH payload) or the half-radio-frame bit may not be necessary.

For example, when there is only one RO for UL WUS transmission irrespective of a detected SSB index, and when a reference SSB index for providing time/frequency allocation of UL WUS relative to SSB can be based on any detected SSB index, the UE need not determine an SSB index, and therefore an IE in the MIB for k_SSB or corresponding scrambling information in the PBCH may not be needed, and such bits/parameters can be used to indicated other information related to UL WUS configuration (or with more precise granularity).

In various methods and example throughout the present disclosure, including the following examples for UL WUS configuration information, whenever a parameter or IE is mentioned to be predetermined, such IE or parameter can be predetermined in the specifications of system operation (same for all frequency bands/ranges, or can be based on a corresponding frequency range/band), or can be preconfigured such as by OAM.

In various example throughout the present disclosure, including the following examples for UL WUS configuration information, whenever an IE or field is mentioned to be provided by MIB, such indication can be understood to be provided by PBCH such as by higher layer BCCH channel/message, a content of which may be referred to as MIB or may be referred to as other message class/type, such as UL WUS or another term.

For example, the first parameters for PRACH/UL WUS preamble generation (e.g., jointly provided by resource-Config-WUS, or separately provided by a parameter preamble-Config-WUS) can include one or more of:
PRACH preamble format: can be indicated by MIB, separately or jointly coded with certain other parameters, such as time-domain offset values, as subsequently discussed among the second parameters (resource-Config-WUS);
PRACH preamble sequence length (L_{RA}): can be selected from a predetermined set of values based on a predetermined association with the set of PRACH preambles, such as a set of values {839, 139}, with L_{RA}=839 for long PRACH preamble formats 0/1/2/3, and L_{RA}=139 for short PRACH preamble formats A1/A2/A3/B1/B2/B3/B4/C0/C2. If additional L_{RA} values are needed for the same PRACH preamble formats, the L_{RA} value can be also jointly encoded with time-domain offset values, as subsequently discussed among the second parameters (resource-Config-WUS);
PRACH logical root sequence (prach-RootSequenceIndex): can be predetermined, for example, based on the cell ID. For example,

$$prach - RootSequenceIndex = {N}_{ID}^{cell} mod ( {L}_{RA} - 1 ) ;$$

SCS for PRACH resource allocation (msg1-SubcarrierSpacing to determine parameter Δf): can be indicated by the PBCH/MIB, for example, separately using the MIB field subCarrierSpacingCommon that is specified to (also) apply to the ‘initial’ PRACH for UL WUS, or using a parameter different from the common SCS, or can be jointly coded with certain other parameters. Other T/F resource allocation fields, such as time-domain offset or frequency-domain offset values, as subsequently described, are determined based on the indicated SCS. In another variation, the SCS can be same as an SCS for SSB and (may or) may not be indicated by the MIB. In another option, an SCS for PRACH/UL WUS can be predetermined or preconfigured for a corresponding frequency range/band;
Cyclic shift restriction (restrictedSetConfig): may be absent, for example, a default value such as ‘unrestrictedSet’ may apply;
Cyclic shift values (zeroCorrelationZoneConfig to determine parameter N_{CS}): can have a default value, such as zero, or can take a value based on a predetermined association with one or both of cell ID or the PRACH preamble format, such as

$${N}_{CS} = {N}_{ID}^{cell} mod 16 ; \cdot or {N}_{CS} = 1 + {N}_{ID}^{cell} mod 15.$$

Alternatively, can be indicated by the PBCH/MIB, separately or jointly encoded with certain other parameters;
Number/Set of PRACH preambles (totalNumberOfRA-Preambles or ra-PreambleStartIndex or groupBconfigured): These parameters can be absent, so that any/all 64 PRACH preambles are available for UL WUS. Alternatively, a predetermined number or set of PRACH preambles can be used for or dedicated to UL WUS transmission, such as a same number of PRACH preambles as a (maximum) supported number of SSB indexes in a frequency ranges, for example, 4 PRACH preambles for frequency bands below 3 GHz, or 8 PRACH preambles for 3-6 GHz (or for the entire FR1), or 64 PRACH preambles for FR2 frequency bands. For example, there can be a one-to-one association between supported SSB time indexes (regardless of whether a certain SSB index is actually transmitted or not) and PRACH preamble indexes, so that a maximum number of PRAC preambles can be same as a maximum number of SSB indexes supported for a corresponding frequency range/band. In another example, a number or set of PRACH preambles may be indicated by the MIB or one-to-many or many-to-one association between SSB indexes and PRACH preambles may be determined by the UE (e.g., the UE 116) or indicated by the MIB. For example, Msg3/A PUSCH transmission is not expected in association with UL WUS, and grouping PRACH preambles based on the PUSCH payload such as group-B (groupBconfigured) may not apply.
Other PHY parameters for PRACH preamble generation: such as Δf_{RA}, μ₀, k̅, Nᵤ,

$${N}_{CP}^{RA}$$

can be derived from previously described parameters, such as the PRACH preamble format, L_{RA}, and Δf.

For example, the second parameters for T/F resource for UL WUS (resource-Config-WUS) includes one or more of:
Number of OFDM symbols

$$( {N}_{dur}^{RA}$$

part of prach-ConfigurationIndex): Can be predetermined based on the PRACH preamble format or other PRACH parameters;
Number of RBs (parameter

$${N}_{RB}^{RA} ) :$$

can be predetermined in the specifications of system operation, with one-to-one association with one or a combination of some of the other parameters, such as, a combination of PRACH preamble format, Δf, and Δf_{RA}.
Time-domain placement of RO(s) for UL WUS (prach-ConfigurationIndex): in one alternative, can be independent of the frame boundary, such as without knowledge of the frame index, subframe index, and slot index. For example, an indication in MIB can be in terms of one or both of a symbol offset and a slot offset, with respect to a first (or last) symbol or slot of the SSB, such as a first (or last) symbol or slot of a reference SSB index, or a first (or last) symbol of a slot that includes the reference SSB index or a first (or last) symbol of a slot that is after the reference SSB index. For example, the specifications of system operation or OAM pre-configuration can include a table for candidate values of symbol offset or slot offset, and the parameter in the PBCH/MIB indicates a row from the table. For example, the specifications can include multiple tables for different modes of operation (such as different frequency ranges or different duplex modes or SCS) and the UE applies a table corresponding to the operation mode for a detected SSB.
   For example, different symbol offset or slot offset values may be used for different PRACH preambles, so the specifications can include a table that jointly encodes the symbol/slot offset and the PRACH preamble format, and a codepoint provided by the MIB indicates a combination of values for the PRACH preamble format and the symbol/slot offset values.
   For example, the symbol offset can take a limited set of values, such as {0, ±1, 2, [±3]} symbols relative to a first (or last) symbol of the reference SSB.
   When, multiple RACH occasions (ROs) for UL WUS are supported for any given SSB burst, and when more than one time division multiplexed (TDMed) ROs are provided in a same slot, a symbol offset between the consecutive TDMed ROs can be predetermined in the specifications, e.g., 2 symbols, or can be provided as a parameter in the table for symbol/slot offset values from a candidate set of values such as {1, 2, 3, 4} symbols, or a symbol offset for the second/third/etc. TDMed ROs in a same slot can be provided as a separate parameter, such as two/three/etc. symbol offset values relative to a first (or last) symbol of the reference SSB. In another example, TDMed ROs are disabled.
   For example, the reference SSB index can be SSB index #0.
   For example, the reference SSB index can be a last/largest actually transmitted SSB index in the SSB burst. For example, the information of such last SSB index can be indicated in the MIB separately or jointly with the symbol/slot offset values. In such option, the PBCH/MIB needs to also provided information of SSB index (via explicit IE or via PHY parameters such as PBCH scrambling or states).
   For example, any SSB index can be used as a reference, including any SSB index that a UE detects. In such option, a content of PBCH/MIB may need to vary based on SSB index, such that a same placement of RO (or an RO in same slot or slot group) can be indicated regardless of a placement/slot/symbol of the detected SSB index. For example, MIB/PBCH information for smaller SSB indexes indicate larger time-domain offset values and MIB/PBCH information for larger SSB indexes indicate smaller time-domain offset values.
   For example, when the UE receives an SSB, the UE can determine an SSB time index associated with the SSB using the SSB sequence parameters or PBCH content.
   For example, a structure of SSB is predetermined in the specifications of system operations, and the UE can determine a relative time-domain position of SSB index #0 (e.g., how many symbols or slots before or after) from any SSB index that the UE has received/detected, regardless of whether or not SSB index #0 is actually transmitted by the gNB, or regardless of whether or not SSB index #0 is received by the UE. For example, the UE can determine a relative time-domain position of a last actually transmitted SSB index (when a corresponding index is indicated to the UE) from any SSB index that the UE has received, regardless of whether or not the UE received such last SSB index.
   When the UE detects an SSB that is in a TDD frequency band, the UE may not be aware of a TDD pattern applicable to a cell. For example, a TDD UL-DL configuration may be transparent to the UE before SIB1 activation, and not provided by the MIB. For example, an indication of time-domain position of RO(s) for UL WUS takes the TDD pattern into account. For example, the slot offset and symbol offset are selected such that the RO(s) for UL WUS fall in UL symbols or slots of a corresponding TDD UL-DL pattern. Accordingly, different tables for symbol/slot offset may be predetermined in the specifications for FDD bands compared to TDD bands, and may also include different tables for different frequency ranges, such as FR1-TDD bands, FR3-TDD bands, FR2-1 TDD bands, or FR2-2 TDD bands. For example, in order to accommodate DL-heavy TDD configuration, the indication can be additionally or alternatively based larger time-domain granularity, such as slot groups, for example groups of 2 or 4 or 8 slots, or 2 or 5 or 10 slots, and the time-domain offset can be in terms of number of slot groups or can be in terms of a combination of a first number of slot groups and a second number of slots. The granularity for slot group can be provided as a separate IE in the PBCH/MIB/UL WUS configuration.
   In a variation, when the UE detects an SSB that is in a TDD frequency band, the gNB may operate the cell with a first TDD UL-DL pattern such as an UL heavy pattern before the SIB1 activation or in NES mode, and with a second TDD UL-DL pattern such as an DL-heavy pattern after the SIB1 activation or in non-NES mode, wherein the first and second TDD patterns are different (as for SIB1/RRC reconfiguration of TDD UL-DL pattern for one or all UEs after SIB1 activation). For example, as SSB is the only applicable DL transmission by the gNB before SIB1 activation, most of the slots can be configured as UL slots, and a TDD UL-DL pattern can be e.g. DDUU . . . UU (2 DL slots and 18 UL slots in a 20 msec period) or DDDDUU . . . UU (4 DL slots and 16 UL slots in a 20 msec period) or the like for a 15 kHz cell operating in an FR1 TDD band. For example, the gNB operates the cell with few DL slots to accommodate SSB transmission by the gNB, and many UL slots to accommodate ROs for UL WUS transmission by the UEs. For example, such UL-heavy configuration of the TDD UL-DL pattern is transparent to the UE, and is only used to flexibly configure limited values for the slot offset of ROs for the UL WUS, without risk for collision with the DL slots. For example, after SIB1 activation, the gNB can operate the cell with a different, e.g., a downlink heavy, TDD UL-DL pattern, such as DDDDU (4 DL slots and 1 UL slot in a 5 msec period) or the like to accommodate a typical operation of the cell with mostly DL traffic. For example, such TDD UL-DL pattern is provided and known to the UE by SIB1 or RRC signaling.
   In one example, a slot offset for UL WUS provides a gap between a slot of the reference SSB and a slot of the only RO for UL WUS or a slot of a first RO for the UL WUS. For example, the only/first RO after an SSB burst can be in the first one or two slots after the SSB burst, or the first one or two UL slot(s) of the applicable TDD UL-DL pattern for the cell (before SIB1 activation) after the SSB burst. For example, the only/first RO after an SSB burst can be with a certain positive or negative (or zero) gap from a predetermined number of slots for a full SSB burst, e.g., equivalent to 5 msec. For example, negative gap can be applicable when an actual SSB burst is shorter than a full SSB burst, such as when the SSB actually includes SSB indexes 0 and 1 (instead of a full SSB burst of indexes 0 to 3) for operation below 3 GHz.
   For example, the actual values of SSB offset that are predetermined in table(s) in the specifications can evaluate the potential length of the SSB burst, the TDD UL-DL configuration, the values of gap, if any, between the SSB burst and the ROs, the number of ROs, the number of frequency division multiplexed (FDMed) ROs, if applicable, the number of SSBs per RO, the definition of the reference RO, and so on.
      For example, when the reference SSB is SSB index #0, and SSBs map to a single RO for UL WUS, the slot offset can take a value L+k, wherein L is a predetermined number of slots based on a length of a full SSB burst in the indicated SCS (or the SSB SCS), and k is an additional positive or negative (or zero) slot offset relative to the end of the full SSB burst. For example, L=2 slots for operation below 3 GHz, L=4 slots for operation between 3 GHz to 6 GHz, and L is a predetermined number for operation above 6 GHz (e.g., no larger than 10 slots for SCS=30 kHz, or 20 slots for SCS=60 kHz, or 40 slots for SCS=120 kHz). For example, a value of L is fixed and predetermined in the specifications for any given frequency range and SCS value, and need not be signaled to the UE, and may not be part of a table for the indicated symbol/slot offset or can be preconfigured. For example, table(s) for indicating the symbol/slot offset only include(s) values for the parameter k. For example, k={0, ±1} slots for operation below 3 GHz, or k={0, 1, 2, 3} slots for operation between 3-6 GHz, or k={0, ±1, ±2, ±4, ±6, ±8, . . . , ±(L−1)} slots for operation above 6 GHz, or a subset or superset or variation thereof. In another example, negative values of k can include {−1, −2, −3, . . . , −(L−1)} or a subset thereof, but non-negative values are limited, e.g., only values {0, 1, 2, 3} slots independent of the L value. In another example, the summands of the summation L+k are not separately defined in the specifications, and the sum value is directly provided in the predetermined table(s) for slot offset.
      For example, when the reference SSB is a last actually transmitted SSB index, and SSBs map to a single RO for UL WUS, the slot offset can be in terms of two parameters (L, k), where L is an index of the last actually transmitted SSB, and k is a positive (or zero) offset relative to the end of the last actually transmitted SSB index. For example, the RO for UL WUS is k slots after a slot for an SSB index L. For example, the table for slot offset can include values of both parameters (L, k). For example, to reduce a number of table rows and a number of bits for the corresponding MIB field, a parameter L can be a quantized upper (or lower) bound to the value of the last actually transmitted SSB index, and a value of k can also take negative values. For example, a method like SLIV in 5G NR can be used to jointly encode the pair of parameters (L, k).
      For example, when there are multiple ROs for UL WUS for any given SSB burst, such as one RO per SSB index or one RO per N SSB indexes, the UE can determine a time-domain position of a first/starting RO for UL WUS based on the methods herein, such as parameters L and k parameters, as previously described. For example, such methods apply at least when the reference SSB is SSB index #0, or when the reference SSB is a last actually transmitted SSB index. For example, the UE can determine time-domain position of remaining ROs from the position of the first/starting RO based on a configuration of ROs for UL WUS, such as FDMed ROs or SSB-to-RO association rules or TDMed ROs in the same slot, as subsequently described.
      In another variation, when there are multiple ROs for UL WUS for any given SSB burst, and the reference SSB index can be any SSB index that the UE detects/receives, a time-domain position of an RO associated with the SSB index can be given by a slot offset relative to a slot for the detected/received SSB index. For example, a same slot offset M can apply to SSB indexes. For example, candidate values of the slot offset M can be such that they map to valid ROs in UL slots for possible SSB indexes. For example, the slot/symbol offset M can take values from a set {1, 2, 3, 4, 5, 6, 8, 10, 15, 20, 30, 40, 50, 60, 80, 100, 120, 160} slots/symbol, or a subset or superset or variation thereof (depending on the operation frequency range, duplex mode, SCS value, and so on). For example, such method applies when FDMed ROs are not supported for UL WUS, or when MIB indicates no FDMed RO for the cell. For example, such method applies when simplified SSB-to-RO association rules are evaluated, such as no TDMed ROs per SSB, or when an SSB-to-RO association parameter indicates one SSB per RO.
      For example, in other cases, such as TDMed ROs in a same slot, or FDMed ROs, or more than SSB per RO, the UE can determine the ROs based on a slot offset value and additional rules or parameters, such as an inter-RO gap or pattern, for example, a periodic or semi-persistent or two-stage/burst pattern, and so on, relative to the SSB position, as subsequently described.
      For example, the UE first determines an RO for a reference SSB index, and then, based on the SSB index and an SSB-to-RO association rule such as with one RO per SSB, assigns all possible/supported SSB indexes in a corresponding frequency range/band to ROs, first in ascending order of FDM'ed ROs, then in ascending order of RACH slots in a slot, and then in ascending order of slots. For example, the UE applies a certain “inter-RO” gap from ROs in one slot/RACH slot to ROs in a next slot/RACH slot. For example, the UE determines ROs based on a predetermined periodicity, or a periodicity that is preconfigured for UL WUS, or can be jointly encoded with time-domain parameters for the UL WUS as previously described. An RO associated with the reference SSB index can be among, such as in the middle of, ROs determined for the possible/supported SSB indexes, based on an index of the reference SSB.

In another alternative, time-domain position of the RO(s) for UL WUS can be based on the frame boundary. For example, SFN information can be provided as part of MIB and/or PBCH. Based on a predetermined structure for the SSB, the UE can determine indexes for frames, subframes, slots, or other time-domain resource units. Therefore, an indication in the MIB can indicate information, similar to prach-ConfigurationIndex, of one or more of frame index, subframe index, and slot index, or symbol index for one or more RO(s) for UL WUS. For example, for a TDD band, the MIB can provide TDD-UL-DL-ConfigCommon or TDD-UL-DL-Pattern or a variation thereof. The UE can determine RO(s) for UL WUS in UL symbols or slots of the indicated TDD UL-DL pattern.
Frequency-domain placement of RO(s) for UL WUS (msg1-FrequencyStart): in one alternative, can be independent of the T/F resource grid or the common resource grid. For example, the UE may not be aware of Point A. For example, an indication in the MIB for the RO(s) of UL WUS can be in terms of RB offset and/or resource element (RE) offset relative to a lowest (or highest) RB or RE of the SSB that the UE has acquired/detected. In another example, a reference SSB index in frequency domain may be determined or indicated, such as when the UE operates with advanced antenna structures, such as joint phase-time arrays (JPTA).
   For TDD bands, it is assumed that the frequency resources in the UL direction overlap with those in the DL direction, therefore, such offset values can have a small range. For example, a first RB/RE of an RO for UL WUS (such as a first/earliest RO in the SSB-to-RO association or an RO associated with the reference SSB index) can be aligned with a first RB/RE of an SSB index, such as SSB index #0 or the detected SSB index, or the reference SSB index. In another example, the frequency information IE can indicate an RB/RE-level offset for the RO(s) relative to the SSB allocation.
   For FDD bands, the frequency resources for DL and UL are separated at least by the FDD duplexing gap, so the offset values can have a large range. Several methods can be evaluated in order to have a MIB field common for FDD and TDD with as few bits as possible for indication of the frequency-domain of RO(s) for UL WUS transmission. In one method, an RB-level offset in the MIB can be with respect to a larger granularity, such as RBG, including for example 4 or 6 or 8 or 16 RBs, wherein an RBG size can be predetermined or indicated by the MIB. In another method, MIB can indicate both an RB-level offset and an RBG-level offset, and the UE combines the two offsets to determine the total offset.
   It is noted that, for the purpose of UL WUS transmission, the UE may not be indicated that a corresponding band is TDD or FDD (although the UE may determine such information by implementation, for example, based on the sync raster). In another example, MIB can include information of TDD vs. FDD, for example, explicitly via a flag/field, or implicitly via other parameters, such as a value of an RBG parameter as previously described (e.g., RBG size equal to 1 can indicate TDD, while RBG size greater than 1 can indicate FDD).

In another alternative, frequency-domain position of the RO(s) for UL WUS can be based on absolute frequency information, such as information of Point A, absolute frequency position of SSB or the downlink/uplink cell or corresponding initial BWP, or corresponding frequency band. For example, MIB may provide some of the parameters offsetToPointA, absoluteFrequencyPointA, FreqBandIndicator[6G] and so on.

In another example, a same IE can be used to jointly encode both the time-domain information and the frequency domain information.
For example, in FDD bands:
   few or no bits can be used to indicate a time-domain offset, such as a time-domain offset of an RO, such as a first RO or a reference RO, from the set of ROs for the UL WUS, for example, by starting from a predetermined number of slot offset after the reference SSB index, or based on a small number of possible candidate slot offset values that are indicated by the UL WUS configuration;
   more bits can be used to indicate frequency-domain offset, such as the duplex gap and other frequency gap, as previously described.
For example, for TDD bands:
   More bits can be used to indicate a time-domain offset to ensure ROs fall in UL symbols or slots of the TDD UL-DL pattern, as previously described;
   Few or no bits can be used to indicate a frequency-domain offset, as a reference RO can be mostly aligned in frequency domain with a reference SSB, and small or no RB/RE offset may be needed, as previously described;
Therefore, a total number of bits can be allocated for the joint indication of time offset and frequency offset, with different bit allocations to time versus frequency offset based on a corresponding duplex mode (FDD/TDD/XDD) or based on a corresponding frequency range/band. For example, the allocation can be provided by codepoints that point to rows of a table, where each row includes a pair/combination of time-offset and frequency offset. For example, for FDD bands, multiple rows can share a same time offset and have different frequency offset. For example, for TDD bands, multiple rows can share a same frequency offset and have different time offsets. For example, time offset can include one or both of symbol-level offset and slot-level offset. For example, frequency offset can include one or both of RE-level offset and RB-level offset.
When slot groups are used (for example for TDD bands) or when RBGs are used (for example for FDD bands) to indicate the respective time offset or frequency offset more efficiently or with different/larger/coarse granularity, the corresponding time/frequency granularity, such as slot group size or RBG size, can be provided separately, or can be provided jointly, for example, using codepoints to rows of another table that includes pairs/combinations of slot group size/time granulite and RBG size/frequency granularity. Alternatively, such granularity can be also jointly coded into the table for time offset and frequency offset, as previously described, so that each row of the table includes a combination of time offset, time offset granularity, frequency offset, and frequency granularity. For example, time offset can include symbol/slot-level offset(s) and symbol/slot-group offset values, and the granularity applies only to the symbol/slot-group offset. For example, frequency offset can include RE/RB-level offset(s) and RE/RB-group offset values, and the granularity applies only to the RE/RB-group offset.

In one example, based on NR RRC “frequencyBandList”, a carrier can belong to multiple frequency bands, and when the UE finds an SSB, the UE may not a priori know a corresponding frequency band. For example, SIB1 can indicate a list of frequency bands associated with the carrier/SSB.

| | |
|---|---|
| Frequency InfoDL-SIB ::= | SEQUENCE { |
| frequencyBandList | MultiFrequencyBandListNR-SIB, |
| offsetToPointA | INTEGER (0..2199), |
| scs-SpecificCarrierList | SEQUENCE (SIZE (1..maxSCSs)) |

OF SCS-SpecificCarrier
}

List of one or multiple frequency bands to which this carrier(s) belongs. If frequencyBandList-v1760 is present, it shall contain the same number of entries listed in the same order as infrequencyBandList (without suffix).
FDMed ROs (msg1-FDM): can be indicated by the MIB, for example, separately or jointly with other parameters, or can be predetermined in the specifications, such as only one RO in frequency domain per time-domain resource (that is, no FDMed ROs) or can be set to maximum supported number of FDMed ROs such as 8 FDMed ROs per time-domain resource, or all ROs can be FDMed, or a number of FDMed ROs can be based on a maximum number of ROs that can fit within the carrier/channel/BWP bandwidth;
SSB-to-RO association (ssb-perRACH-OccasionAndCB-PreamblesPerSSB): can be present, for example, when the UE can transmit the UL WUS in different ROs based on a detected SSB. For example, an SSB-to-RO association can be predetermined in the specifications, such as one SSB per RO, or can be indicated by MIB, as some gNBs may be capable of receiving multiple beams within the same RO.
   In another example, an SSB-to-RO association may be absent, for example, as the gNB (e.g., the BS 102) is already transmitting the SSB in certain time indexes corresponding to certain gNB-Tx beams/spatial filters. For example, SSBs may be mapped to a single RO for UL WUS. For example, upon reception of the UL WUS, the gNB can activate (i.e., start transmitting) the SIB1 in the corresponding beams/spatial filters. For example, the gNB can use any of the corresponding beams/spatial filters for the UL WUS reception. For example, a gNB may operate with multiple antenna arrays or panels, or may operate with advanced antenna structures, such as JPTA, and the gNB may be able to receive multiple UL WUS transmissions from multiple UEs associated with different beams in the same RO or in FDMed ROs.
RSRP threshold for SSB selection (rsrp-ThresholdSSB): can be provided by MIB, with 8 bits as in 5G NR (RSRP-Range), or in a compact form, based on larger granularity, such as only 2 bits (4 extended ranges). For example,

$$ext\_RSRP \_Range = ⌊ \frac{RSRP\_Range}{32} ⌋ ,$$

wherein └⋅┘ is the floor function, such that RSRP-Range=with index 0 to 31 correspond to extended RSRP range #0, and so on. In another example, such RSRP threshold may be absent, for example, when SSBs are mapped to a single RO for UL WUS, and selection of a certain SSB does not impact the procedure.

For example, the third parameters for transmission-related and other follow-up procedures (Tx-Config-WUS) includes one or more of:
Parameters for determining a transmission power for the UL WUS (such as one or more of ss-PBCH-BlockPower, preambleReceivedTargetPower, powerRampingStep, p-Max, emission power levels, etc.): can be provided by the MIB, with same ranges as in 5G NR, or with compact ranges, for example, based on large granularity, and can be indicated separately or jointly with each other or with other parameters. For example, certain combinations of SSB Tx power and PRACH target Rx power may be indicated, and other combinations may be excluded, such as small SSB Tx power with large target Rx power, or vice versa. For example, the UE determines a pathloss for the UL WUS transmission by comparing ss-PBCH-BlockPower with the SSB received power. For example, the UE determines a maximum configured transmission power P_{c,max} or variation thereof based on the configured power limits for the cell or for UL WUS, such asp-Max, emission power levels, and so on. Determination of UE Tx power for UL WUS is subsequently described.
   In another example, UE's transmit power for UL WUS is directly provided by the MIB (rather than indicating the received power and parameters for path loss (PL) calculation). For example, power parameter values can have ranges similar to 5G NR, or can have fewer and extended/larger ranges. For example, when an extended power range is indicated, the UE is predetermined to transmit with a reference value, such as the lowest value in the range or with a median value of the range.
   In another example, such parameters may be absent. For example, a Tx power value for UL WUS, such as an initial value and a power ramp-up value if supported/applicable, can be predetermined in the specifications. For example, the UE can be specified to transmit the UL WUS with maximum supported power, such as 23 dBm. For example, when SIB1 is deactivated, the gNB does not receive any UL transmission in the cell, and UL power control may not be necessary for the purpose of UL WUS detection. For example, in order to reduce a potential inter-cell interference caused by the UL WUS, the gNB can indicate information of T/F resource(s) of RO(s) for UL WUS to neighbor gNBs, using inter-gNB signaling, such as over the Xn interface or the like, and such T/F resource(s) can be avoided by the neighbor gNBs.
Maximum number of UL WUS transmissions (preambleTransMax): can be jointly encoded with other MIB fields, such as UL power control parameters, if any, for example, the power ramping value (such that, for example, combinations with large power ramping step and large max number of transmissions are excluded) or can be predetermined in the specifications. When the UE reaches such maximum number of UL WUS attempts, and the UE fails to detect SIB1 for the cell (for example, the MIB flag is not updated to indicate that SIB1 is activated on the cell), the UE stops the procedures, and attempts to access a different cell.
RAR window for UL WUS (ra-Response Window): may be absent, as a response to UL WUS may not be supported. In another example, RAR for UL WUS may be supported and a length of the RAR window may be predetermined in the specifications, such as 1 or 2 or 4 slots, as, before SIB1 activation, the gNB is not receiving or transmitting any other DL/UL signal or channel, other than SSB and PRACH/UL WUS, and the RAR window can be short. When RAR response to UL WUS transmission is supported, the UE receives information of RAR parameters, such as CORESET #0 and SS #0 for RAR reception, RAR window parameters, and so on, as part of the UL WUS configuration that is included in the

Other PRACH related parameters, such as the following, may not be expected or relevant for the purpose of UL WUS transmission, and may be absent in the MIB:
ra-PrioritizationForAccessldentity-r16,
rsrp-ThresholdSSB-SUL,
ra-PrioritizationForSlicing-r17,
featureCombinationPreamblesList-r17
msg3-transformPrecoder,
ra-ContentionResolutionTimer
IAB-relatedPRACHparameters,

For example, other variations or extension may be supported, such as the following:
The MIB can be provided by a PBCH of an SSB (i.e., a PSS/SSS/PBCH block, e.g., as in 5G NR) or can be provided as information bits overlaid on PSS/SSS sequences, without a need for a PBCH, or certain parameters described as part of MIB may be excluded from the MIB and provided by the PBCH payload, or based on the time/frequency resource allocation of the SSB, such as number of RBs/REs/symbols/slots, or corresponding T/F offset values such as k_offset, or corresponding spatial domain/beams, and so on.
Separate or same fields in MIB for SIB1 information and for indication of UL WUS config
   For example, UL WUS such as RACH is only used when SIB1 is deactivated, and same bits can be used for UL WUS configuration and SIB1 PDCCH configuration.
   For example, MIB information content can be updated to adapt to the two use-cases.
For example, other options can be evaluated for including the UL WUS configuration inside the MIB/PBCH/SSB:
   For example, using separate fields for SIB1 PDCCH and UL WUS, such as when MIB/PBCH/SSB can carry sufficient number of bits (e.g., more RBs for PBCH);
   For example, different channels are defined for providing the UL WUS configuration and SIB1 PDCCH configuration. For example, a SIB0/MIB2 or PBCH #2 can be appended to the PBCH/MIB of the SSB.
For example, the MIB can provide the first and the second information (for SIB1 PDCCH configuration and for UL WUS configuration, respectively) separately, such as separate bits/fields, or same field/bits can indicate both the first and the second information.
For example, the UE (e.g., the UE 116) can determine whether SIB1 transmission is activated or deactivated on the cell by UE implementation, such as by attempting to decode the PDCCH for SIB1 based on the first information provided by the MIB, or the MIB can include a flag that indicates whether SIB1 is activated or deactivated.
For example, when multiple ROs are supported for UL WUS transmission, an SSB-to-RO association for UL WUS transmission can be same as that for PRACH in 5G NR, or can be a simplified association, such as frequency first, if supported/indicated, and time second. For example, if ROs are TDMed, the SSBs are sequentially mapped to the ROs, based on the indicated time-domain offset. For example, when FDMed ROs or association of multiple SSBs to one RO is supported, the UE associates first SSB indexes to first ROs in a first symbol/slot first, before associating the next/second SSBs to next/second ROs in a second symbol/slot that is after the first symbol/slot.
For example, similar designs for PRACH configuration (e.g., for PHY generation, resource allocation, and transmission parameters) can be extended to other signals or channels that provide an UL WUS functionality, such as
   Cell-specific SRS or other sequence-based design, or
   Cell-specific PUCCH, e.g., PUCCH format 0/1.
For example, the gNB may activate SIB1 in SSB indexes/beams with which the gNB receives the initial PRACH. For example, the gNB may switch off (i.e., not transmit) SIB1 associated with certain SSB indexes/beams without any associated initial PRACH/UL WUS transmission.
For example, the UE may monitor a response, such as RAR, upon transmission of UL WUS, such as an initial/compact RACH
   For example, RAR can be cell-specific or UE-specific.
   For example, the UE determine RAR monitoring window, RA-RNTI, PDCCH MO for RAR.
   For example, contents of RAR include a number of fields, such as a RAPID.
   For example, contention may not be critical for UL WUS transmission, such as when transmissions from different UEs do not cancel out each other, as a purpose for UL WUS is to wake up the gNB, rather than distinguishing an identity of a triggering UE.
   For example, when a UE transmits an UL WUS such as an initial/compact PRACH and does not receive the SIB1, the UE may attempt to transmit PRACH again a number of times, with power ramp-up, at least up to a predetermined or indicated maximum number of PRACH preamble transmissions.
For example, there may be a relation between an initial/compact PRACH for UL WUS purpose and a (full) RA procedure for RRC connection establishment.
   For example, a full RA configuration can be separate from the compact RA config.
   For example, the full RA config can be based on the compact RA config.
      For example, RACH resources (ROs, preambles, etc.) for compact PRACH can be same/overlapping or different/separate from ROs for full PRACH.
      For example, in case of reused/shared RACH resources between compact PRACH and full PRACH, the gNB may attempt to distinguish the UE, such as by a RAR transmission, or the UE gNB may not transmit a RAR as such operation may be performed after SIB1 activation.
   For example, a UE can use a same PRACH preamble in full RA as that used for compact RA, and that may be used by the gNB for faster identification of the UE, such as when transmitting a RAR.
   For example, a response to UL WUS such as compact RAR may include one or more of: TA, back-off indication, assistance information for RRC establishment by the UE. For example, the compact RAR may include one or more of TC-RNTI, UL grant for Msg3, a trigger for early CSI/tracking reference signal (TRS)/SRS, and so on.
For example, for a UE that does not intend to perform initial access on a cell with deactivated SIB1 (such as a UE only making SSB measurements, as part of neighbor-cell RRM), the UE can request SIB1 for that cell on its own camped/serving cell (using RACH, with additional RACH clause for requesting SIB1 for a non-serving cell), or can request the SIB1 for that cell on the same cell without SIB1 (using compact RACH, similar to a UE that intends to perform initial access).
For example, a UE can provide assistance-information to the gNB for deactivating SIB1. For example, the UE may indicate to the gNB that the UE has no UL traffic, or no expected UL traffic with a certain time duration in future, or may indicate a request to be released, such as for UE power saving purposes. For example, when the gNB has released most or all of the UEs in the cell, the UE may deactivate the transmission of the SIB1.
For example, a UE can establish connection using the (initial) PRACH before SIB1 is activated, and then the UE can receive SIB1 by UE-specific signaling.
   For example, before SIB1 activation, the UE can receive any cell barring info from an (initial) RAR.

For example, a transmit power of UL WUS can be based on a target received power of the UL WUS/PRACH as provided by the UL WUS configuration in the MIB, and a full compensation (e.g., alpha=1) of a pathloss value that the UE determines based on the detected or reference SSB index.

In one embodiment, a UE can identify or be provided information of an energy-efficient DL Anchor signal, such as a low-power synchronization signal (LP-SS) or an aperiodic synchronization signal/SSB (A-SSB) or a periodic SSB (P-SSB) with long periodicity, that can provide:
a first-stage/coarse synchronization signal, or
an indication whether (the on-demand) SSB SIB1 are currently activated or deactivated in the cell, or
(as part of an “initial MIB”) configuration information for an uplink wake-up signal or channel, such as (a compact or full configuration for) a PRACH transmission, to request for (the on-demand) SSB and SIB1 when indicated as deactivated in the cell, or
assistance information for the UE to (faster) detect (the on-demand) SSB (and SIB1) when indicated as activated in the cell.

When a UE detects a DL Anchor signal that indicates no (on-demand) SSB and SIB1 activated on PCell, the UE can transmit the uplink wake-up/SSB-request signal or channel, in time/frequency/spatial resources associated with the DL Anchor signal as identified based on the (“initial MIB”) information. The UE may not receive any RAR in response to the PRACH, or may receive a RAR that provides assistance-information about (the on-demand) SSB (and SIB1) to be activated on the cell.

Regardless of a RAR transmission by the gNB or not, the gNB can activate (or may not choose to activate) (the on-demand) SSB and SIB1 transmission on the cell upon reception of UL WUS/PRACH. The indication provided by the DL Anchor signal is also updated to indicate that (the on-demand) SSB and SIB1 are activated. In addition, the DL Anchor provides assistance-information about the (one-demand) SSB, such as (relative) T/F resource for the SSB or SSB position-in-burst (i.e., which SSB indexes/are activated), and so on.

The gNB can deactivate the (on-demand) SSB and SIB1 on the cell, based on gNB implementation, such as based on a gNB-side inactivity timer/event, for example, no UL transmission in the cell for a time duration larger than a certain threshold, (or based on UE assistance information, for example, as previously described). When the gNB deactivates the (on-demand) SSB and SIB1 on the cell, the indication on the DL Anchor signal is updated to indicate no (on-demand) SSB and SIB1 activated on the PCell.

It is noted that, the UE may not use the DL Anchor signal for RRC establishment. The UE establishes the RRC connection upon receiving an activated (on-demand) SSB, which provides MIB (e.g., as in 5G NR), and receiving SIB1 with scheduling information on the MIB provided by the activated SSB (e.g., as in 5G NR). When SSB is not activated on the cell, the UE cannot establish RRC connection to the cell. For example, the UE requests for SSB1 and SIB1 activation, and establishes the RRC connection when SSB and SIB1 are activated on the cell.

For example, several extensions or variations of the method herein may be supported, such as the following:
For example, the DL Anchor signal, e.g., LP-SS or aperiodic SSB (AP-SSB), can include same/overlapping or separate/different occasions for DL Anchor and for the (on-demand) SSB, TDM/FDM multiplexing.
For example, indication of SSB activated/deactivated is explicit e.g. overlaid info on sequence, or implicit e.g., certain values for the sequence parameters, (or based on measurement similar to entry/exit condition in LP-WUS),
For example, configuration information for the compact PRACH—similar to E-1
   OOK-based PRACH or OFDM-based PRACH
   RAR in response to compact PRACH
   additional interaction between compact PRACH and full PRACH
   assistance information for RRC establishment based on the previous compact RACH
For example, the gNB can be equipped with a low-power (LP) receiver/transmitter/transceiver, also referred to as LP radio (LR), for one or both of OOK-based (or other low-power modulations, such as OOK-variants or PSK/FSK and so on) LP-SS/LP-PBCH/LP-WUS transmission and OOK-based UL WUS/PRACH reception. For example, the gNB may operate such LP radio along with a main radio (MR) for the OFDM-based transmissions or receptions at a same time, or the gNB may switch between the LR and the MR. For example, during NES mode/SIB1 deactivation, the gNB can operate with the LR and during the non-NES mode/SIB1 activation, the gNB can operate with the MR. It is noted that, the LR may be used for reception/transmission of certain UL or DL OFDM-based channels or signals. It is noted that, the MR may be used for reception/transmission of certain UL or DL OOK-based channels or signals.
For example, the LP-SS or DL Anchor can provide assistance-info for the activated SSB, e.g., relative T/F, beam info, and so on. For example, such information can be used for synchronization, cell search, RRM, paging when both DL Anchor and activated SSB are present.
For example, a certain UE implementation may skip monitoring the DL Anchor and directly searches for the (on-demand SSB): (i) before SSB activation, and (ii) after SSB activation
For example, additional energy efficiency can be achieved based on omni-directional LP-SS (no LP-SS burst)
   Reduced LP-SS overhead; along with beam management (BM) latency handling;
   No “LPSS-to-RO” association;
For example, there can be interaction between the compact RA based on LP-SS and the full RA based on SSB
   The UE to use an SSB index for the full RA which is “QCL” with the LP-SS used for compact RA
For example, paging can be based on LP-SS that is used for compact RA.

In one embodiment, UE/gNB signaling and procedures can be same as one or more embodiments described herein, except that when SSB is activated on a cell, the DL Anchor signal is deactivated, and vice versa. The UE independently monitors (i.e., searches for) both the DL Anchor signal and the SSB.

When the UE detects the SSB, the UE can perform initial access (e.g., as in 5G NR) by reading SIB1 and performing random access to establish RRC connection, or the UE may only perform SSB measurement e.g. for RRM purposes.

When the UE detects the DL Anchor signal, the UE determines that SSB and SIB1 are not activated/transmitted on the cell (without need for any indication by the DL Anchor signal, as in one or more embodiments described herein), and the UE can transmit the UL wake-up signal or channel, such as (the compact or full) PRACH to request for SSB and SIB1. When the gNB receives (the compact or full) PRACH, the gNB activates the SSB and SIB1 transmission on the cell, and deactivates the DL Anchor signal.

The gNB can deactivate the SSB and SIB1 on the cell, based on gNB implementation (or based on UE assistance information, for example, as previously described). When the gNB deactivates the SSB and SIB1 on the cell, the gNB activates (i.e., starts transmitting) the DL Anchor signal.

It is noted that, the UE may not use the DL Anchor signal for RRC establishment. When SSB is not activated on the cell, the UE cannot establish RRC connection to the cell. For example, the UE requests for SSB1 and SIB1 activation, and establishes the RRC connection when SSB and SIB1 are activated on the cell.

In one embodiment, a UE can receive a DL Anchor signal, as described in one or more embodiments herein, and the UE can establish RRC connection based on the DL Anchor signal (unlike one or more embodiments herein), based on the information of the uplink wake-up signal or channel, such as PRACH, and without using (including before transmission of) an activated SSB and SIB1. Upon detection of the DL Anchor signal, the UE completes a two-step or 4-step RACH procedure based on the PRACH configuration provided by the DL Anchor signal, to establish the RRC connection. Once the UE establishes the RRC connection, the UE can receive on-demand SSB for improved synchronization and RRM measurements, and on-demand SIB1 using cell-specific or UE-specific RRC signaling.

For example, a MIB-like message, such as LP-MIB, can be provided by the LP-SS, or by a low-power channel associated with the LP-SS, such as LP-PBCH, wherein an LP-PBCH may be transmitted along with, such consecutive with or TDM or FDM with LP-SS. In another example, LP-MIB may be provided as parameters of LP-SS sequence or in terms of the time-frequency allocation or placement of LP-SS, such as number or index of symbols/slots/REs/RBs used for LP-SS.

In one example, the UE may receive RAR/Msg3/Contention resolution for (OFDM-based or OOK-based) PRACH associated with LP-SS, wherein Msg2/3/4 can be based on OFDM or OOK waveform.

In one example, the UE can perform paging based on LP-SS, such as reception of OFDM-based or low-power (e.g., OOK-based) paging PDCCH/physical downlink shared channel (PDSCH) in association with LP-SS.

In one embodiment, a UE, such as a 6G UE, can perform RRM and mobility measurements or procedures based on a DL Anchor signal, such as LP-SS or AP-SSB (or P-SSB with longer periodicity), as described in one or more embodiments herein, or using UE-specific/on-demand (SSB or) CSI-RS, including configuration of UE-specific or cell-specific CSI-RS before or after RRC connection or configuration of UE-specific or cell-specific CSI-RS on a neighbor/non-serving cell, instead of using cell-specific, periodic/always-on SSB. Such configurations or procedures, in some cases, may also rely on (possibly tight) inter-gNB coordination.

In one embodiment, a UE can operate with an aperiodic SSB (AP-SSB) for synchronization, random access, measurements, RRM/mobility, and so on. The AP-SSB, in each transmission/reception occasion, can include timing information (e.g., symbol or slot or half-frame or frame) of a corresponding time resource of that occasion in which the AP-SSB is transmitted/received.

Before RRC connection, the UE can be provided AP-SSB as a DL Anchor signal for coarse synchronization or for providing information of an UL wake-up signal, such as (compact or full) PRACH, as described in one or more embodiments herein. The UE can be provided (predetermined or higher layer) information of an interval duration, in which the UE is guaranteed to receive at least one occasion of an AP-SSB. The AP-SSB can also include timing information of a next AP-SSB occasion.

After RRC connection, the UE can be triggered to receive AP-SSB, for example, a DCI format, such as a scheduling DCI or a standalone DCI) can include a trigger field (similar to a CSI report trigger field in 5G NR) to indicate one or more AP-SSBs and information about transmission/reception occasions thereof. The UE can also provide information of AP-SSB measurement, and same (or different) trigger can indicate the UE to report measurements corresponding to the one or more AP-SSBs, such as L1 or L3-filtered RSRP, reference signal received quality (RSRQ), or signal-to-interference-plus-noise ratio (SINR).

For example, such AP-SSB may apply before RRC connection or after RRC connection establishment.

In various embodiments or examples throughout the present disclosure, a 6G base station (referred to as, “6G node-B” or for short “6G NB”) or a 5G gNB can be replaced with other corresponding network nodes, such as 6G integrated access and backhaul (IAB) or 6G network-controlled repeater (NCR) or 6G reconfigurable intelligent surface (RIS), or such as 5G NCR or IAB node, or other corresponding relay or repeater nodes. In various embodiments, a 6G UE or a 5G UE can operate in relation with multiple network nodes corresponding to a certain RAT (same RAT as that for the UE, or different RAT than that for the UE), such as both a 6G NB and a 6G IAB/NCR/RIS, or both a 5G gNB and a 5G IAB/NCR, or both a 4G eNB and 4G relay/repeater node.

In various embodiments and examples throughout the present disclosure, a 6G NB or a 5G gNB or a 4G eNB can refer to a central unit (CU) or a distributed unit (DU) or a remote unit (RU) or a transmission-reception point (TRP) or other architectural units or functional/logical entities for a corresponding base station, for example based on O-RAN architecture, or a variation or collection or combination thereof. For example, similar designs can continue to apply to multi-TRP/multi-DU settings.

In one embodiment, a cell, such as a 6G PCell, can operate with an (existing, as in 5G, or a modified) SSB that provides a master information block (MIB), along with a SIB1 transmission that can be activated or deactivated on the cell. The MIB can include both first information for SIB1 PDCCH, such as CORESET #0 and SS #0, and second information for configuration of an uplink NB-wake-up signal or channel or a SIB1-request signal or channel, such as a (compact or full) configuration for (an initial) random access (RA). The MIB can provide the first and the second information separately, such as separate bits/fields, or same field/bits can indicate both the first and the second information. The UE can determine whether SIB1 transmission is activated or deactivated on the cell by UE implementation, such as by attempting to decode the PDCCH for SIB1 based on the first information provided by the MIB, or the MIB can include a flag that indicates whether SIB1 is activated or deactivated.

When the UE identifies that SIB1 is activated on the cell, the UE can proceed (e.g., as in 5G NR) to camp on the cell or to perform initial/random access and RRC connection establishment with the cell or to perform RRM measurements on the cell.

When the UE identifies that SIB1 is deactivated on the cell, the UE can transmit the uplink NB-wake-up/SIB1-request signal or channel, such as the (initial) PRACH based on the (compact or full) configuration provided by the second information in MIB, to request for reception of SIB1. The UE transmits the uplink NB-wake-up/SIB1-request signal or channel, such as the (initial) PRACH, using time/frequency (or spatial filter) associated with an SSB (or PSS/SSS) that the UE determines for camping on the cell or for initial/random access or identifies for RRM measurement.

Once the gNB (e.g., the BS 102) receives the (initial) PRACH, the gNB activates (i.e., starts transmitting) the SIB1 on the cell. The UE attempts to receive the PDCCH for SIB1 based on the first information already provided in the MIB, or the ULE may receive (updated) SIB1 PDCCH information, such as new information for CORESET #0 or SS #0, in a wake-up response, such as a random-access response (RAR), that the UE receives in response to the transmission of the uplink wake-up/SIB1-request signal or channel. In next occasions of SSB transmission, the gNB can update the MIB flag value (if present) to indicate that SIB1 is activated. In addition, the gNB may keep transmitting other MIB information same as in previous SSB occasions before reception of the uplink wake-up/SIB1-request signal or channel (for example, the same first information as before), or the gNB can provide updated MIB information, updated first information for SIB1 PDCCH (if needed).

The gNB can deactivate the (on-demand) SIB1 on the cell, based on gNB implementation, such as based on a gNB-side inactivity timer/event, for example, no UL transmission on the cell for a time duration larger than a certain threshold, (or based on UE assistance information). When the gNB deactivates the on-demand SIB1 on the cell, the MIB flag (if present) is updated to indicate that SIB1 is deactivated on the cell, and can update the first information for SIB1 PDCCH (if needed).

It is noted that, a UE may proceed to camp on the cell or perform initial/random access to establish RRC connection to the cell after SIB1 is activated on the cell. For example, a transmission of the uplink wake-up/request signal or channel, such as the (initial) PRACH transmission, is not (necessarily) for the purpose of establishing RRC connection, and instead is [mainly] for the purposes of requesting on-demand SIB1. For example, the UE may not attempt to camp on the cell or perform initial/random access to establish RRC connection to the cell before SIB1 is activated on the cell. Once the UE receives the on-demand SIB1, the UE can proceed to establishing RRC connection (for example, as in 4G/5G), such as by determining a (full) RA configuration for establishing RRC connection, and performing a 4-step or 2-step RACH operation.

In one example, an uplink wake-up signal or channel for SIB1 request can be a PRACH, such as a PRACH based on OFMD waveform, or a PRACH based on OOK-waveform.

In one example, uplink wake-up signal or channel for SIB1 request can be an uplink cell-specific signal, such as an uplink cell-specific SRS.

In one example, a flag that indicates whether SIB1 is activated or deactivated on the cell can be provided as an explicit field/bit in MIB, such as using the spare MIB field in the 5G NR MIB, or can be as an information bit overlaid on PSS/SSS sequences (for example, as values of sequence parameter), wherein the synchronization signal may or may not include a PBCH.

In one example, an indication of whether SIB1 is activated or deactivated can be provided by repurposing the MIB fields. For example, when a cellBarred field of the MIB is set to ‘notBarred’, the UE determines that SIB1 is activated on the cell, and proceed to receiving the SIB1.

For example, when the cellBarred field of the MIB is set to ‘barred’, the cell may or may not be barred based on other MIB fields:
When a field in the MIB, other than cellBarred field and intraFreqReselection field, such as the dmrs-TypeA-Position field (or one bit of a multi-bit field from other MIB fields, such as CORESET #0 or SS #0 configuration or UL WUS configuration, and so on), is set to a predetermined value, such as 0, the cell is regarded as barred, and corresponding UE procedures applies (for example, cell reselection in the same frequency band or a different frequency band, depending on a value of the intraFreqReselection field). Such field/bit is herein referred to as a validation field/bit for cell barring;
When the validation field/bit for cell barring in the MIB is not set to the predetermined value, for example, set to 1, the cell is regarded as not barred, while SIB1 is deactivated. For example, some or all of the remaining MIB fields/bits can be repurposed for providing a configuration for the uplink wake-up signal or channel, such as “initial” PRACH, for SIB1 request, as subsequently described.

| | |
|---|---|
| MIB ::= | SEQUENCE { |
| systemFrameNumber | BIT STRING (SIZE (6)), |
| subCarrierSpacingCommon | ENUMERATED |
| | {scs15or60, scs30or120}, |
| ssb-SubcarrierOffset | INTEGER (0..15), |
| dmrs-TypeA-Position | ENUMERATED {pos2, pos3}, |
| pdcch-ConfigSIB1 | PDCCH-ConfigSIB1, |
| cellBarred | ENUMERATED {barred, |
| | notBarred}, |
| intraFreqReselection | ENUMERATED {allowed, |
| | notAllowed}, |
| spare | BIT STRING (SIZE (1)) |

}

In various examples, a reference to “(on-demand) SSB” or “(on-demand) SIB” can refer to “SSB (such as periodic SSB or on-demand SSB or aperiodic SSB)” or “SIB (such as periodic SIB or on-demand SIB or aperiodic SIB)”, respectively, and variants therefo.

In one embodiment, a UE (e.g., the UE 116) can identify or be provided information of an energy-efficient DL Anchor signal or channel, such as a low-power synchronization signal (LP-SS) or an aperiodic synchronization signal/SSB (A-SSB) or a periodic SSB (P-SSB) with long periodicity, that can provide:
a first-stage/coarse synchronization signal, or
an indication whether SSB/SIB1 (such as on-demand SSB/SIB1) are currently activated or deactivated in the cell, or
(as part of an “initial MIB”) configuration information for an uplink wake-up signal or channel, such as (a compact configuration for) a PRACH transmission, to request for (the on-demand) SSB and SIB1 when indicated as deactivated in the cell, or
assistance information for the UE to (faster) detect (the on-demand) SSB (and SIB1) when indicated as activated in the cell.

When a UE detects a DL Anchor signal that indicates no (on-demand) SSB and SIB1 activated on PCell, the UE can transmit the uplink wake-up/SSB-request signal or channel, in time/frequency/spatial resources associated with the DL Anchor signal as identified based on the (“initial MIB”) information. The UE may not receive any RAR in response to the PRACH, or may receive a RAR that provides assistance-information about (the on-demand) SSB (or SIB1) to be activated on the cell.

Regardless of a RAR transmission by the gNB or not, the gNB activates (the on-demand) SSB and SIB1 transmission on the cell. The indication provided by the DL Anchor signal is also updated to indicate that (the on-demand) SSB and SIB1 are activated. In addition, the DL Anchor provides assistance-information about the (one-demand) SSB, such as [relative]T/F resource for the SSB or SSB position-in-burst (i.e., which SSB indexes/are activated), and so on.

The gNB can deactivate the (on-demand) SSB and SIB1 on the cell, based on gNB implementation, such as based on a gNB-side inactivity timer/event, for example, no UL transmission in the cell for a time duration larger than a certain threshold, (or based on UE assistance information). When the gNB deactivates the (on-demand) SSB and SIB1 on the cell, the indication on the DL Anchor signal is updated to indicate no (on-demand) SSB and SIB1 activated on the PCell.

It is noted that, the UE may not use the DL Anchor signal for RRC establishment. The UE establishes the RRC connection upon receiving an activated (on-demand) SSB, which provides MIB (e.g., as in 5G NR), and receiving SIB1 with scheduling information on the MIB provided by the activated SSB (e.g., as in 5G NR). When SSB is not activated on the cell, the UE cannot establish RRC connection to the cell. For example, the UE requests for SSB1 and SIB1 activation, and establishes the RRC connection when SSB and SIB1 are activated on the cell.

In one embodiment, UE/gNB signaling and procedures can be same as one or more embodiments described herein, except that when SSB is activated on a cell, the DL Anchor signal is deactivated, and vice versa. The UE independently monitors (i.e., searches for) both the DL Anchor signal and the SSB. The DL Anchor signal or channel may not include a flag to the activation or deactivation of SSB.

When the UE detects the SSB, the UE can perform initial access (e.g., as in 5G NR) by reading SIB1 and performing random access to establish RRC connection, or the UE may only perform SSB measurement e.g. for RRM purposes.

When the UE detects the DL Anchor signal, the UE determines that SSB and SIB1 are not activated/transmitted on the cell (without need for any indication by the DL Anchor signal, as in one or more embodiments described herein), and the UE can transmit the UL wake-up signal or channel, such as (the compact or full) PRACH to request for SSB and SIB1. When the gNB receives (the compact or full) PRACH, the gNB activates the SSB and SIB1 transmission on the cell, and deactivates the DL Anchor signal.

The gNB can deactivate the SSB and SIB1 on the cell, based on gNB implementation (or based on UE assistance information). When the gNB deactivates the SSB and SIB1 on the cell, the gNB activates (i.e., starts transmitting) the DL Anchor signal.

It is noted that, the UE may not use the DL Anchor signal for RRC establishment. When SSB is not activated on the cell, the UE cannot establish RRC connection to the cell. For example, the UE requests for SSB1 and SIB1 activation, and establishes the RRC connection when SSB and SIB1 are activated on the cell.

In one embodiment, a UE can receive a DL Anchor signal, as described in one or more embodiments described herein, and the UE can establish RRC connection based on the DL Anchor signal (unlike one or more embodiments described herein), based on the information of the uplink wake-up signal or channel, such as PRACH, and without using (including before transmission of) an activated SSB and SIB1. Upon detection of the DL Anchor signal, the UE completes a two-step or 4-step RACH procedure based on the PRACH configuration provided by the DL Anchor signal, to establish the RRC connection. Once the UE establishes the RRC connection, the UE can receive on-demand SSB for improved synchronization and RRM measurements, and on-demand SIB1 using cell-specific or UE-specific RRC signaling.

In one embodiment, a UE, such as a 6G UE, can perform RRM and mobility measurements or procedures based on a DL Anchor signal, such as LP-SS or AP-SSB (or P-SSB with longer periodicity), as described in one or more embodiments described herein, or using UE-specific/on-demand (SSB or) CSI-RS, including configuration of (UE-specific or UE-group-specific or cell-specific) CSI-RS before or after RRC connection or configuration of (UE-specific or UE-group-specific or cell-specific) CSI-RS on a neighbor/non-serving cell, instead of using cell-specific, periodic/always-on SSB. Such configurations or procedures, in some cases, may also rely on (possibly tight) inter-gNB coordination.

In one embodiment, a UE can operate with an aperiodic SSB (AP-SSB) for synchronization, random access, measurements, RRM/mobility, and so on. The AP-SSB, in each transmission/reception occasion, can include timing information (e.g., symbol or slot or half-frame or frame) of a corresponding time resource of that occasion in which the AP-SSB is transmitted/received.

Before RRC connection, the UE can be provided AP-SSB as a DL Anchor signal for coarse synchronization or for providing information of an UL wake-up signal, such as (compact or full) PRACH, as described in one or more embodiments described herein. The UE can be provided (predetermined or higher layer) information of an interval duration, in which the UE is guaranteed to receive at least one occasion of an AP-SSB. The AP-SSB can also include timing information of a next AP-SSB occasion.

After RRC connection, the UE can be triggered to receive AP-SSB, for example, a DCI format, such as a scheduling DCI (or a standalone DCI) can include a trigger field (similar to a CSI report trigger field in 5G NR) to indicate one or more AP-SSBs and information about transmission/reception occasions thereof. The UE can also provide information of AP-SSB measurement, and same (or different) trigger can indicate the UE to report measurements corresponding to the one or more AP-SSBs, such as L1 or L3-filtered RSRP, RSRQ, or SINR.

AP-SSB as “initial discovery signal” that upgrades to P-SSB (or AP-SSB for the entire life-time of the cell).

Aperiodicity on frame-level: SSB can be in any frame→Spec to guarantee a max duration T for finding at least one AP-SSB. For example, the UE expects to find at least one occasion of AP-SSB within the maximum time duration T.

Aperiodicity on symbol-level: SSB can be in any symbol→SSB should include explicit/implicit info about symbol-level SSB as well.

Additional energy saving via reduced SSB usage
exclude SSB from Serving cell RRM, BM/beam failure recovery (BFR)—instead use UE-specific CSI-RS
Whether SSB can be excluded from Neighbor-cell RRM or from IDLE/INACTIVE Mobility—may need tight inter-gNB coordination for neighbor-cell UE-specific CSI-RS

Additional energy saving via omni-directional LP-SS
No LP-SS burst
No “LPSS-to-RO” association
Reduced LP-SS overhead
Increased BM latency

In one example, various designs can be considered for signaling & UE procedure for “turning off” some or all of SSB/MIB/SIB1 on a PCell during gNB “night” or NES mode:
Level-1: Keep SSB periodicity same as NR, but no SIB1-4 UL WUS to trigger SIB1
Level-2: SSB with long periodicity (e.g., 320/640 ms) & No SIB1 4 UL WUS to trigger default SSB periodicity & SIB1
Level-3: low-power DL Anchor signal (e.g., AP-SSB or LP-SS) with long periodicity & No SIB1 4 UL WUS to trigger SSB & SIB1
Level-4: No SSB/LP-SS/DL Anchor in the cell→extended UL WUS only by first UE to trigger SSB & SIB1. For example, the UE transmits a time-continuous UL WUS. Once the gNB detects such WUS, the gNB can start to transmit SSB or LP-SS.

In one example, a first scheme referred to as an adaptive SSB on PCell can be as follows:
In non-NES mode: SSB transmission as in NR (e.g., 20 ms periodicity) and SIB1 enabled
In NES mode: SSB (or LP-SS) Tx & UL WUS Rx with long periodicity (e.g., 320 640 ms) and SIB1 disabled
   gNB Tx/Rx using the main radio (MR)
The UE transmits UL WUS in the NES mode to trigger non-NES mode.

In one example, a second scheme referred to as an on-demand/disabled SSB on PCell can be as follows:
In non-NES mode: SSB transmission as in NR (e.g., 20 ms periodicity) and SIB1 enabled
In NES mode: gNB LP-SS Tx and/or UL LP-WUS Rx with long periodicity (e.g., 320 or 640 ms) and SSB/SIB1 disabled
   gNB Tx/Rx using low-power radio (LR)
   UL LP-WUS configuration via LP-SS/LP-PBCH
The UE transmits UL LP-WUS to trigger non-NES mode.
As a variation, the gNB may alternate between LP-SS and SSB (only one at a time/period).

The present disclosure can be applicable to NR/6G specifications Rel-20/21 or beyond to support reduced energy-efficient initial access.

The embodiments are generic and can also apply to various frequency bands in different frequency ranges (FR) such as FR1, FR2, FR3, and FR2-2, e.g., low frequency bands such as below 1 GHz, mid frequency bands, such as 1-7 GHz, or 7-24 GHz, and high/millimeter frequency bands, such as 24-100 GHz and beyond. In addition, the embodiments are generic and can apply to various use cases and settings as well, such as single-panel UEs and multi-panel UEs, eMBB, URLLC and IIoT, mMTC and IoT including NB-IoT, NR IoT, and Ambient IoT (A-IoT), sidelink/V2X, operation with multi-TRP/beam/panel, operation in unlicensed/shared spectrum (NR-U), non-terrestrial networks (NTN), aerial systems such as drones, operation with reduced capability (RedCap) UEs, private or non-public networks (NPN), and so on.

The present disclosure may also relate to a pre-5th-Generation (5G) or 5G or beyond 5G communication system to be provided for supporting one or more of: higher data rates, lower latency, higher reliability, improved coverage, and massive connectivity, and so on. Various embodiments apply to UEs operating with other RATs and/or standards, such as different releases/generations of 3GPP standards (including beyond 5G, 5G Advanced, 6G, and so on), IEEE standards (such as 802.16 WiMAX and 802.11 Wi-Fi and so on), and so forth.

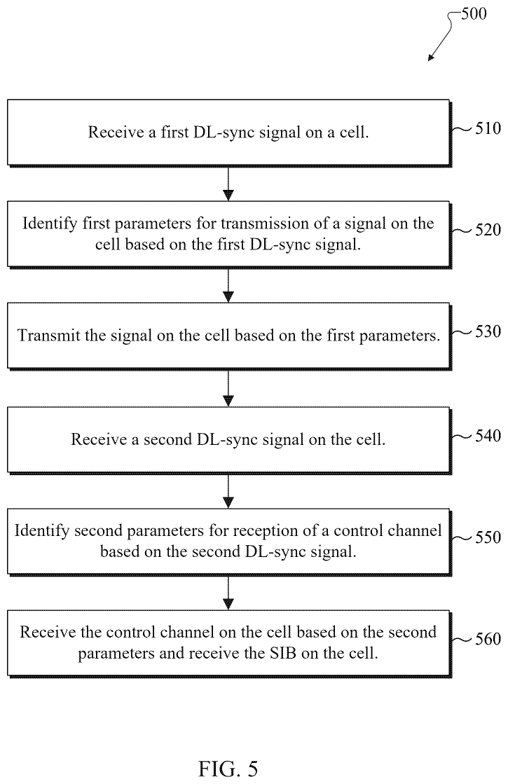

FIG. 5 illustrates an example method 500 performed by a UE in a wireless communication system according to embodiments of the present disclosure. The method 500 of FIG. 5 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 500 is for illustration only and other embodiments can be used without departing from the scope of the present disclosure.

The method 500 begins with the UE receiving a first DL-sync signal on a cell (510). In various embodiments, the first DL-sync signal is a PSS, a PSS and a SSS, a periodic SSB, or an AP-SSB.

The UE then identifies first parameters for transmission of a signal on the cell based on the first DL-sync signal (520). In various embodiments, a first subset of the first parameters is predetermined or preconfigured by OAM and a second subset of the first parameters is indicated by the first DL-sync signal. In various embodiments, the signal is a PRACH, a PUCCH, or a SRS and the first parameters include at least one of a time offset or a frequency offset for the transmission of the signal relative to the reception of the first DL-sync signal, a transmit power for the first DL-sync signal, and power control parameters for the transmission of the signal, including one or both of: a target received power and p-Max.

The UE then transmits the signal on the cell based on the first parameters (530) and receive a second DL-sync signal on the cell (540). In various embodiments, the second DL-sync signal is a SSB, and the second parameters are included in a MIB provided by the SSB. In various embodiments, the first DL-sync signal is associated with a first reference periodicity, the second DL-sync signal is associated with a second reference periodicity, and the first reference periodicity is larger than or equal to the second reference periodicity. In various embodiments, the first DL-sync signal is a first SSB, the second DL-sync signal is a second SSB, each of the first SSB and the second SSB includes a respective flag or a respective message class type indicator that indicates a respective operation mode for the cell, and information content of the first SSB and the second SSB are interpreted based on the respective operation mode.

The UE then identifies second parameters for reception of a control channel based on the second DL-sync signal (550). For example, in 550, the control channel schedules reception of a SIB for the cell. The UE then receives the control channel on the cell based on the second parameters and receive the SIB on the cell (560).

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A method for a user equipment (UE), the method comprising:
receiving a first downlink synchronization (DL-sync) signal on a cell;
identifying, at least based on the first DL-sync signal, first parameters for transmission of a signal on the cell;
transmitting the signal on the cell based on the first parameters;
receiving a second DL-sync signal on the cell;
identifying, based on the second DL-sync signal, second parameters for reception of a control channel, wherein the control channel schedules reception of a system information block (SIB) for the cell;
receiving the control channel on the cell based on the second parameters; and
receiving the SIB on the cell.

2. The method of claim 1, wherein the first DL-sync signal is:
a primary synchronization sequence (PSS),
a PSS and a second synchronization sequence (SSS),
a periodic synchronization signal and physical broadcast channel block (SSB), or
an aperiodic SSB (AP-SSB).

3. The method of claim 1, wherein:
the second DL-sync signal is a synchronization signal and physical broadcast channel block (SSB), and
the second parameters are included in a master information block (MIB) provided by the SSB.

4. The method of claim 1, wherein:
the first DL-sync signal is associated with a first reference periodicity,
the second DL-sync signal is associated with a second reference periodicity, and
the first reference periodicity is larger than or equal to the second reference periodicity.

5. The method of claim 1, wherein:
a first subset of the first parameters is predetermined or preconfigured by Operations, Administration, and Maintenance (OAM), and
a second subset of the first parameters is indicated by the first DL-sync signal.

6. The method of claim 1, wherein:
the first DL-sync signal is a first synchronization signal and physical broadcast channel block (SSB),
the second DL-sync signal is a second SSB,
each of the first SSB and the second SSB includes a respective flag or a respective message class type indicator that indicates a respective operation mode for the cell, and
information content of the first SSB and the second SSB are interpreted based on the respective operation mode.

7. The method of claim 1, wherein:
the signal is a physical random-access channel (PRACH), a physical uplink control channel (PUCCH), or a sounding reference signal (SRS), and
the first parameters include at least one of:
a time offset or a frequency offset for the transmission of the signal relative to the reception of the first DL-sync signal,
a transmit power for the first DL-sync signal, and
power control parameters for the transmission of the signal, including one or both of: a target received power and an emission power (p-Max).

8. A user equipment (UE) comprising:
a transceiver configured to receive a first downlink synchronization (DL-sync) signal on a cell; and
a processor operably coupled with the transceiver, the processor configured to identify, at least based on the first DL-sync signal, first parameters for transmission of a signal on the cell;
wherein the transceiver is further configured to:
transmit the signal on the cell based on the first parameters, and
receive a second DL-sync signal on the cell;
wherein the processor is further configured to identify, based on the second DL-sync signal, second parameters for reception of a control channel, wherein the control channel schedules reception of a system information block (SIB) for the cell; and
wherein the transceiver is further configured to:
receive the control channel on the cell based on the second parameters, and
receive the SIB on the cell.

9. The UE of claim 8, wherein the first DL-sync signal is:
a primary synchronization sequence (PSS),
a PSS and a second synchronization sequence (SSS),
a periodic synchronization signal and physical broadcast channel block (SSB), or
an aperiodic SSB (AP-SSB).

10. The UE of claim 8, wherein:
the second DL-sync signal is a synchronization signal and physical broadcast channel block (SSB), and
the second parameters are included in a master information block (MIB) provided by the SSB.

11. The UE of claim 8, wherein:
the first DL-sync signal is associated with a first reference periodicity,
the second DL-sync signal is associated with a second reference periodicity, and
the first reference periodicity is larger than or equal to the second reference periodicity.

12. The UE of claim 8, wherein:
a first subset of the first parameters is predetermined or preconfigured by Operations, Administration, and Maintenance (OAM), and
a second subset of the first parameters is indicated by the first DL-sync signal.

13. The UE of claim 8, wherein:
the first DL-sync signal is a first synchronization signal and physical broadcast channel block (SSB),
the second DL-sync signal is a second SSB,
each of the first SSB and the second SSB includes a respective flag or a respective message class type indicator that indicates a respective operation mode for the cell, and
information contents of the first SSB and the second SSB are interpreted based on the respective operation mode.

14. The UE of claim 8, wherein:
the signal is a physical random-access channel (PRACH), a physical uplink control channel (PUCCH), or a sounding reference signal (SRS), and
the first parameters include at least one of:
a time offset or a frequency offset for the transmission of the signal relative to the reception of the first DL-sync signal,
a transmit power for the first DL-sync signal,
power control parameters for the transmission of the signal, including one or both of: a target received power and an emission power (p-Max).

15. A base station comprising:
a transceiver configured to transmit a first downlink synchronization (DL-sync) signal on a cell; and
a processor operably coupled with the transceiver, the processor configured to identify, at least based on the first DL-sync signal, first parameters for reception of a signal on the cell;
wherein the transceiver is further configured to:
receive the signal on the cell based on the parameters, and
transmit a second DL-sync signal on the cell;
wherein the processor is further configured to identify, based on the second DL-sync signal, second parameters for transmission of a control channel, wherein the control channel schedules transmission of a system information block (SIB) for the cell; and
wherein the transceiver is further configured to:
transmit the control channel on the cell based on the second parameters, and
transmit the SIB on the cell.

16. The base station of claim 15, wherein the first DL-sync signal is:
a primary synchronization sequence (PSS),
a PSS and a second synchronization sequence (SSS),
a periodic synchronization signal and physical broadcast channel block (SSB), or
an aperiodic SSB (AP-SSB).

17. The base station of claim 15, wherein:
the second DL-sync signal is a synchronization signal and physical broadcast channel block (SSB), and
the second parameters are included in a master information block (MIB) provided by the SSB.

18. The base station of claim 15, wherein:
the first DL-sync signal is associated with a first reference periodicity,
the second DL-sync signal is associated with a second reference periodicity, and
the first reference periodicity is larger than or equal to the second reference periodicity.

19. The base station of claim 15, wherein:
the first DL-sync signal is a first synchronization signal and physical broadcast channel block (SSB),
the second DL-sync signal is a second SSB,
each of the first SSB and the second SSB includes a respective flag or a respective message class type indicator that indicates a respective operation mode for the cell, and
information contents of the first SSB and the second SSB are interpreted based on the respective operation mode.

20. The base station of claim 15, wherein:
the signal is a physical random-access channel (PRACH), a physical uplink control channel (PUCCH), or a sounding reference signal (SRS), and
the first parameters include at least one of:
a time offset or a frequency offset for the transmission of the signal relative to the reception of the first DL-sync signal,
a transmit power for the first DL-sync signal,
power control parameters for the transmission of the signal, including one or both of: a target received power and an emission power (p-Max).
